(19) United States
(12) Patent Application Publication
(10) Pub. No.: US 2023/0362725 A1
(43) Pub. Date: Nov. 9, 2023

(54) Connection Configuration Change

(71) Applicant: Telefonaktiebolaget LM Ericsson (publ), Stockholm (SE)

(72) Inventors: Massimo Condoluci, Solna (SE); Stefano Sorrentino, Solna (SE); Tomas Nylander, Värmdö (SE)

(21) Appl. No.: 17/610,987

(22) PCT Filed: May 6, 2020
(86) PCT No.: PCT/EP2020/062630

§ 371 Date: Nov. 12, 2021

Related U.S. Application Data
(60) Provisional application No. 62/847,095, filed on May 13, 2019.

(51) Int. Cl. H04W 28/086; H04W 28/12

(52) U.S. Cl. CPC H04W 28/086; H04W 28/12

(57) ABSTRACT

There is provided a method performed by a wireless device (14) that comprises radio equipment (14A) and terminal equipment (14B). The method comprises receiving connection reconfiguration signaling from a wireless communication network at the radio equipment (14A) of the wireless device (14). The connection reconfiguration signaling indicates reconfiguration of a connection that the radio equipment (14A) has with the wireless communication network. The method comprises transmitting, from the radio equipment (14A) to the terminal equipment (14B) of the wireless device (14), notification signaling (26) that notifies the terminal equipment of the reconfiguration of the connection.

### TECHNICAL FIELD

The disclosure relates to methods for managing changes in connection configuration and entities configured to operate in accordance with those methods.

### BACKGROUND

A wireless device includes radio equipment (also referred to as radio processing circuitry) that maintains a connection with a wireless communication network. This connection may be dynamically reconfigurable, e.g., to account for changes in channel conditions, network load, or the like. For example, the connection may be reconfigured to use so-called coverage enhancement (CE) if the wireless device's channel conditions worsen. Reconfiguring the connection in this and other ways may advantageously adapt the connection as needed in different circumstances, while relieving the wireless device's applications and operating system from the burden of managing the underlying connection that they use.

### SUMMARY

It is an object of the disclosure to obviate or eliminate at least some of the disadvantages associated with existing techniques involving connection reconfiguration.

Therefore, according to an aspect of the disclosure, there is provided a method performed by a wireless device that comprises radio equipment and terminal equipment. The method comprises receiving connection reconfiguration signaling from a wireless communication network at the radio equipment of the wireless device. The connection reconfiguration signaling indicates reconfiguration of a connection that the radio equipment has with the wireless communication network. The method also comprises transmitting, from the radio equipment to the terminal equipment of the wireless device, notification signaling that notifies the terminal equipment of the reconfiguration of the connection.

According to another aspect of the disclosure, there is provided a method performed by a wireless device that comprises radio equipment and terminal equipment. The method comprises receiving, at the terminal equipment of the wireless device, notification signaling indicating reconfiguration of a connection that the radio equipment of the wireless device has with a wireless communication network.

According to another aspect of the disclosure, there is provided a method performed by a wireless device that comprises radio equipment and terminal equipment. The method comprises transmitting, from the terminal equipment of the wireless device to endpoint communication equipment, notification signaling indicating one or more of reconfiguration of a connection that the radio equipment of the wireless device has with a wireless communication network and adaptation of one or more parameters at the terminal equipment in accordance with the reconfiguration of the connection. The connection supports data transfer between the wireless device and the endpoint communication equipment.

According to another aspect of the disclosure, there is provided a method performed by a radio network node configured for use in a wireless communication network. The method comprises transmitting connection reconfiguration signaling from the radio network node to a wireless device. The connection reconfiguration signaling indicates reconfiguration of a connection that radio equipment of the wireless device has with the radio network node. The method also comprises transmitting, from the radio network node to a core network node in the wireless communication network, notification signaling that notifies the core network node of the reconfiguration of the connection.

According to another aspect of the disclosure, there is provided a method performed by a core network node configured for use in a wireless communication network. The method comprises receiving, from a radio network node in the wireless communication network, notification signaling indicating reconfiguration of a connection that radio equipment of a wireless device has with the radio network node.

According to another aspect of the disclosure, there is provided a method performed by a core network node configured for use in a wireless communication network. The method comprises transmitting, from the core network towards endpoint communication equipment, notification signaling indicating one or more of reconfiguration of a connection that radio equipment of the wireless device has with a radio network node and adaptation of one or more parameters at the core network node in accordance with the reconfiguration of the connection. The connection supports data transfer between the wireless device and the endpoint communication equipment.

According to another aspect of the disclosure, there is provided a method performed by endpoint communication equipment. The method comprises transmitting or receiving notification signaling indicating one or more of reconfiguration of a connection that radio equipment of a wireless device has with a radio network node and adaptation of one or more parameters in accordance with the reconfiguration of the connection. The connection supports data transfer between the wireless device and the endpoint communication equipment.

According to another aspect of the disclosure, there is provided a method performed by a network node configured for use in a wireless communication network. The method comprises determining, based on one or more decision criteria, whether to trigger reconfiguration of a connection between a wireless device and the wireless communication network and/or how to reconfigure the connection. The one or more decision criteria include one or more of location information for the wireless device, channel information for the wireless device, communication traffic information for the wireless device, subscription information for the wireless device, one or more limitations on reconfiguration of the connection, one or more capabilities of the wireless device, or loading information for the wireless communication network.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a schematic illustrating a wireless communication network according to some embodiments;

FIG. 2 is a block diagram illustrating a wireless device according to some embodiments;

FIG. 3 is a schematic illustrating a wireless communication network according to some embodiments;

FIG. 4 is a flow chart illustrating a method performed by a wireless device according to some embodiments;

FIG. 5 is a flow chart illustrating a method performed by a wireless device according to some embodiments;

FIG. 6 is a flow chart illustrating a method performed by a radio network node according to some embodiments;

FIG. 7 is a flow chart illustrating a method performed by a core network node according to some embodiments;

FIG. 8 is a flow chart illustrating a method performed by endpoint communication equipment according to some embodiments;

FIG. 9 is a block diagram illustrating a wireless device according to some embodiments;

FIG. 10 is a block diagram illustrating a network node according to some embodiments;

FIG. 11 is a block diagram illustrating endpoint communication equipment according to some embodiments;

FIG. 12 is a signalling diagram illustrating an exchange of signals element according to some embodiments;

FIG. 13 is an example coverage enhancement element according to some embodiments;

FIG. 14 is an example of a physical channel reconfiguration according to some embodiments;

FIG. 15 is a signalling diagram illustrating an exchange of signals element according to some embodiments;

FIG. 16 is a signalling diagram illustrating an exchange of signals element according to some embodiments;

FIG. 17 is a schematic illustrating a wireless network according to some embodiments;

FIG. 18 is a schematic illustrating a wireless device according to some embodiments;

FIG. 19 is a block diagram illustrating a virtualization environment according to some embodiments;

FIG. 20 is a schematic illustrating a telecommunication network according to some embodiments;

FIG. 21 is a block diagram illustrating a wireless device, network node, and host computer according to some embodiments;

FIG. 22 is a flow chart illustrating a method performed by a communication system according to some embodiments;

FIG. 23 is a flow chart illustrating a method performed by a communication system according to some embodiments;

FIG. 24 is a flow chart illustrating a method performed by a communication system according to some embodiments;

FIG. 25 is a flow chart illustrating a method performed by a communication system according to some embodiments;

FIG. 26A-B is a signalling diagram illustrating an exchange of signals element according to some embodiments; and

FIG. 27A-B is a signalling diagram illustrating an exchange of signals element according to some embodiments.

### DETAILED DESCRIPTION

Some embodiments herein expose at least some aspects of connection reconfiguration to the wireless device's applications and/or operating system, e.g., so that the applications and/or operating system can exploit that connection reconfiguration as an optimization opportunity themselves. Such optimizations may for instance involve limiting the amount of data generated, or disabling certain data-hungry applications, e.g., in favor of improved connection robustness. In some embodiments, for instance, the wireless device's radio equipment notifies the device's applications and/or operating system of connection reconfiguration. In other embodiments, the network notifies the device's applications and/or operating system of the connection reconfiguration.

More particularly, some embodiments herein include those enumerated in the EMBODIMENTS section below.

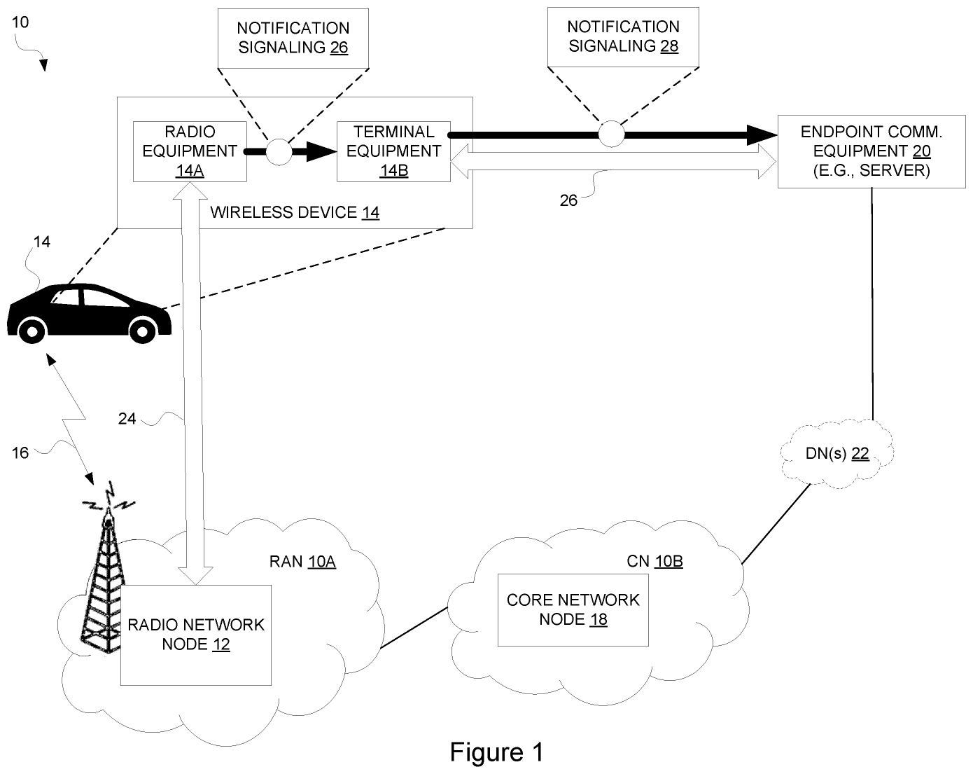

FIG. 1 shows a wireless communication network 10 according to some embodiments. The network 10 includes a radio access network (RAN) 10A and a core network 10B for providing network access to a wireless device 14. In some embodiments, the wireless device 14 may be a user equipment (UE). Alternatively or additionally, the wireless device 14 in some embodiments as shown may be capable of vehicle-to-everything (V2X) communication. Alternatively or additionally, the wireless device 14 may be a device for a vehicle, such as a non-category M1 device, which may be capable of transmitting or receiving over a frequency bandwidth greater than 1.08 Mhz, and/or may be capable of so-called normal coverage (as contrasted with coverage enhancement). In any event, the RAN 10A includes a radio network node 12 (e.g., a base station) that serves the wireless device 14 over a radio interface 16. The CN 10B includes a core network node 18 that provides one or more core network functions for the wireless device 14, e.g., mobility management, session management, etc. The CN 10B interconnects the wireless device 14 to endpoint communication equipment 20 (e.g., an application server, AS, or simply server), e.g., via one or more data networks (DNs) 22 (e.g., the Internet).

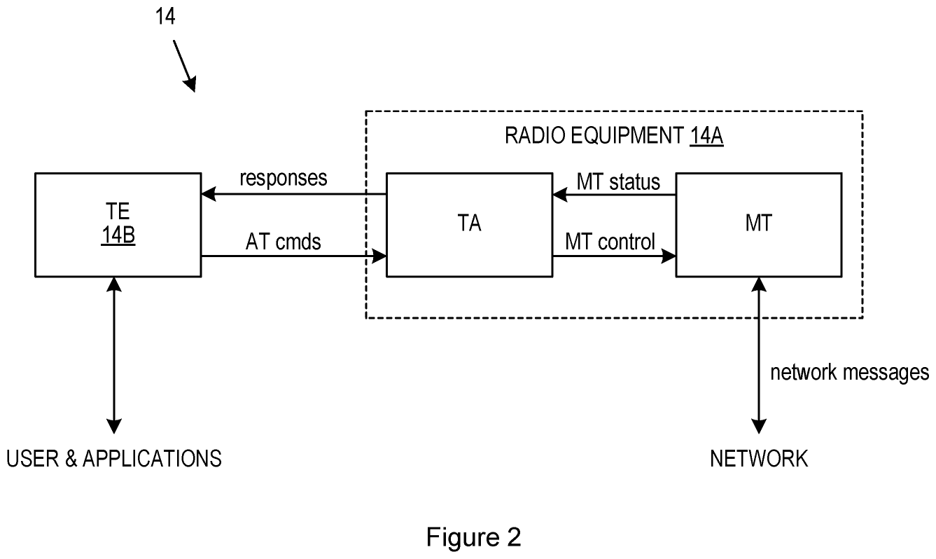

The wireless device 14, more particularly, comprises radio equipment 14A and terminal equipment 14B. The radio equipment 14A may also be referred to interchangeably as radio processing circuitry or radio processing unit. In some embodiments, the radio equipment 14A represents or implements functionality of a terminal adaptor (TA) and/or mobile termination (MT) of the wireless device 14, e.g., as defined in 3GPP TS 27.007 and TS 23.227 and as shown in FIG. 2. As shown in FIG. 2, the MT implements function and network services. Attention (AT) commands can be used for controlling MT functions and network services from the terminal equipment (TE) 14B through the terminal adaptor (TA). The terminal equipment 14B may be a personal computer (PC) or other piece of equipment that can run applications independently. The TA, MT, and TE may be separate entities, or may be integrated in any combination. In some embodiments, the radio equipment 14A may be, comprise, or include a modem of the wireless device 14. Where the wireless device 14 is a user equipment (UE), then, the radio equipment 14A in some embodiments herein may be referred to as a UE modem. In some embodiments, the terminal equipment 14B may support, execute, or otherwise provide one or more applications (Apps) and/or an operating system (OS) on which such application(s) run. Where the wireless device 14 is a UE, therefore, the terminal equipment 14B may represent or correspond to UE App(s) and/or UE OS.

With this understanding, FIG. 1 shows that the radio equipment 14A has a connection 24 with the wireless communication network 10, e.g., with the radio network node 12. The connection 24 may for instance be a control plane connection, e.g., such as a radio resource control (RRC) connection. In this and other cases, the connection 24 between the radio equipment 14A and network 10 may support data transfer 26 between the terminal equipment 14B and the endpoint communication equipment 20, e.g., at an application layer.

In some embodiments, configuration of the connection 24 is network controlled. In this case, the network 10 (e.g., via radio network node 12) may transmit connection reconfiguration signalling (not shown) to the radio equipment 14A, e.g., as it is the radio equipment 14A in some embodiments that manages the connection 24. The connection reconfiguration signalling may indicate reconfiguration of the connection 24, e.g., by indicating one or more configuration parameters for the connection 24. Where the connection 24 is an RRC connection, for instance, the connection reconfiguration signalling may be or may include an RRC reconfiguration message. In some embodiments, the reconfiguration of the connection 24 may include or involve the setup or release of a coverage enhancement (CE) mode for the connection 24. Thus, the reconfiguration of the connection 24 may include or involve a change of CE mode utilization, such as whether the wireless device 14 has changed to operate in CE mode.

Regardless of the particular way in which the connection 24 is reconfigured, the wireless device's radio equipment 14A notably transmits notification signaling 26 to the device's terminal equipment 14B. This notification signaling 26 notifies the terminal equipment 14B of the reconfiguration of the connection 24, e.g., by indicating the fact that reconfiguration of the connection 24 has occurred, by indicating the fact that a certain type of reconfiguration of the connection 24 has occurred, and/or by indicating how the connection 24 has been reconfigured. That is, even though it is the radio equipment 14A that manages the connection 24 according to some embodiments, the radio equipment 14A exposes reconfiguration of the connection 24 to the terminal equipment 14B. Where the terminal equipment 14B represents or executes applications and/or operating system at the wireless device 14, this may mean that the device's application(s) and/or operating system become aware of reconfiguration of the connection 24 via the notification signaling 26.

In some embodiments, though, the radio equipment 14A selectively transmits the notification signaling 26 for only certain types of reconfigurations of the connection 24. The radio equipment 14A in this case may, for any given reconfiguration of the connection 24, determine whether to transmit the notification signaling 26 to the terminal equipment 14B. The radio equipment 14A may for instance filter received connection reconfiguration signaling to extract one or more parameters characterizing the reconfiguration (e.g., CE mode changes). If the parameter(s) indicate the reconfiguration corresponds to certain type(s) of reconfigurations for which notification signaling 26 is to be transmitted, the notification signaling 26 may be sent, e.g., and include or be based on the one or more parameters extracted.

The terminal equipment 14B may correspondingly receive this notification signaling 26. Based on this notification signaling 26, the terminal equipment 14B according to some embodiments may advantageously adapt one or more parameters at the terminal equipment 14B. The parameter(s) may for instance govern data transfer 26 between the terminal equipment 14B and the endpoint communication equipment 20. The parameter(s) in some embodiments may for example govern generation and/or transfer of data between the wireless device 14 and the endpoint communication equipment 20. Alternatively or additionally, the parameter(s) may govern a rate, amount, and/or latency of data transfer between the wireless device 14 and endpoint communication equipment 20. In any event, such adaptation of the parameter(s) may be performed according to or corresponding with the reconfiguration of the connection 24. For instance, the parameter(s) may be adapted so that the data generation and/or transfer comports with the connection reconfiguration. Where the reconfiguration of the connection 24 comprises the setup or release of a CE mode for the connection 24, the adaptation may adapt the rate, amount, and/or latency of data transfer 26 between the wireless device 14 and the endpoint communication equipment 20 to be supportable by the connection 24 as reconfigured. As one example, when the connection 24 is reconfigured from using normal coverage (e.g., without repetitions) to using coverage enhancement (e.g., with repetitions), the terminal equipment 14B may reduce the rate and/or amount of data that it generates, transmits to, and/or receives from the endpoint communication equipment 20, e.g., at an application layer, such that the data transfer 26 better comports with the connection's ability to support that rate and/or amount of data. Alternatively or additionally, the parameter(s) may be adapted to enable or disable a specific application executable by the terminal equipment 14B, e.g., disable applications with high bitrates, low latency and/or large file transfers if the connection uses coverage enhancement. In still other embodiments, the parameter(s) may be adapted to adjust priorities among multiple traffic flows between the wireless device and the endpoint communication equipment 20.

In some embodiments, the terminal equipment 14B in turn transmits notification signaling 28 to the endpoint communication equipment 20. In one such embodiment, this notification signaling likewise indicates reconfiguration of the connection 24, e.g., so as to repeat or propagate the notification signaling 26 received from the radio equipment 14A. Alternatively or additionally, the notification signaling may indicate adaptation of the one or more parameters at the terminal equipment 14B, e.g., in accordance with the reconfiguration of the connection 24. The endpoint communication equipment 20 may then correspondingly exploit this notification signaling 28 to adapt one or more parameters at the endpoint communication equipment 20. In some embodiments, the adaptation may be performed as described above for the terminal equipment 14B, e.g., so that the terminal equipment 14B and endpoint communication equipment 20 each perform adaptations in the same or complementary ways.

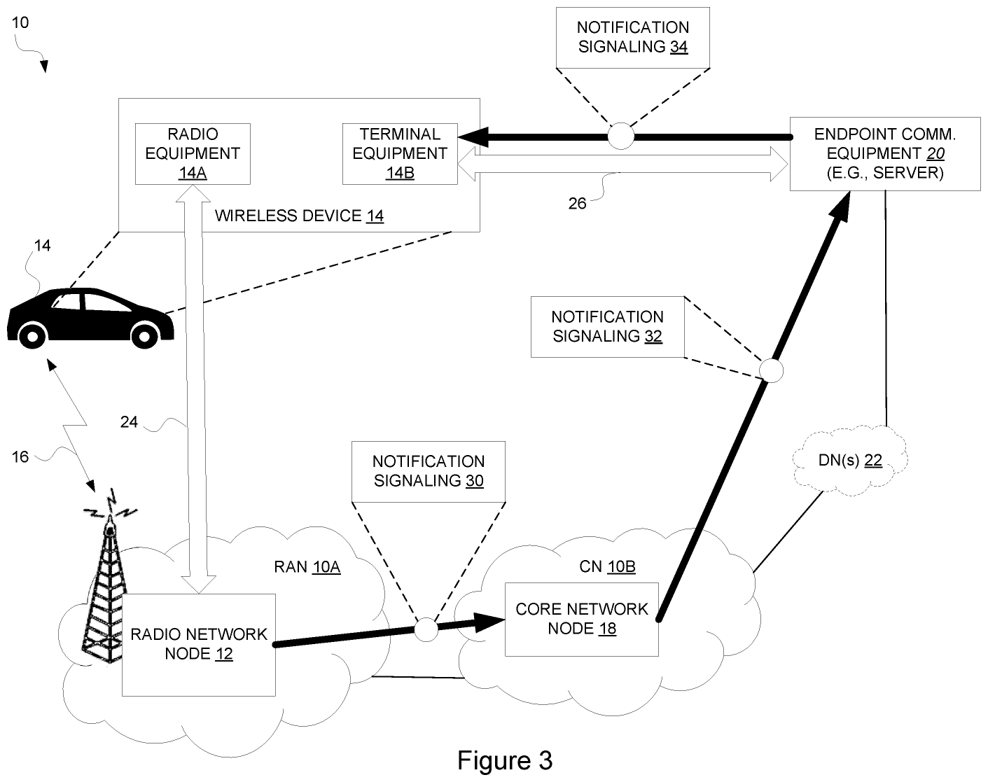

FIG. 1 illustrated some embodiments where the device's radio equipment 14A triggers notification of connection reconfiguration, e.g., based on the radio equipment's determination that such reconfiguration has occurred. FIG. 3 illustrates other embodiments where the radio network node 12 alternatively or additionally triggers notification of connection reconfiguration, e.g., based on the radio network node's determination that such reconfiguration has occurred.

As shown in FIG. 3, the radio network node 12 notably transmits notification signaling 30 to the core network node 18. This notification signaling 30 notifies the core network node 18 of the reconfiguration of the connection 24, e.g., by indicating the fact that reconfiguration of the connection 24 has occurred, by indicating the fact that a certain type of reconfiguration of the connection 24 has occurred, and/or by indicating how the connection 24 has been reconfigured.

In some embodiments, though, the radio network node 12 selectively transmits the notification signaling 30 for only certain types of reconfigurations of the connection 24. The radio network node 12 in this case may, for any given reconfiguration of the connection 24, determine whether to transmit the notification signaling 26 to the core network node 18. The radio network node 12 may for instance filter transmitted connection reconfiguration signaling to extract one or more parameters characterizing the reconfiguration (e.g., CE mode changes). If the parameter(s) indicate the reconfiguration corresponds to certain type(s) of reconfigurations for which notification signaling 26 is to be transmitted, the notification signaling 30 may be sent, e.g., and include or be based on the one or more parameters extracted.

The core network node 18 may correspondingly receive this notification signaling 30. Based on this notification signaling 30, the core network node 18 according to some embodiments may advantageously adapt one or more parameters at the core network node 18. The adaptation may be similar to that described above. Alternatively or additionally, the adaptation may include adaptation of one or more parameters of a network policy for treating the data transfer 26.

In some embodiments, the core network node 18 in turn transmits notification signaling 32 towards the endpoint communication equipment 20, e.g., by transmitting the notification signaling 32 to the endpoint communication equipment or to an application function (AF) associated with the endpoint communication equipment 20. In one such embodiment, this notification signaling 32 likewise indicates reconfiguration of the connection 24, e.g., so as to repeat or propagate the notification signaling 30 received from the radio network node 12. Alternatively or additionally, the notification signaling may indicate adaptation of the one or more parameters at the core network node 18, e.g., in accordance with the reconfiguration of the connection 24. The endpoint communication equipment 20 may then correspondingly exploit this notification signaling 32 to adapt one or more parameters at the endpoint communication equipment 20. In some embodiments, the adaptation may be performed as described above for the core network node 18 and/or the terminal equipment 14B.

In still further embodiments, the endpoint communication equipment 20 may in turn transmit notification signaling 34 to the terminal equipment 14B. In one such embodiment, this notification signaling 34 likewise indicates reconfiguration of the connection 24, e.g., so as to repeat or propagate the notification signaling 30 received from the radio network node 12. Alternatively or additionally, the notification signaling may indicate adaptation of the one or more parameters at the endpoint communication equipment 20, e.g., in accordance with the reconfiguration of the connection 24.

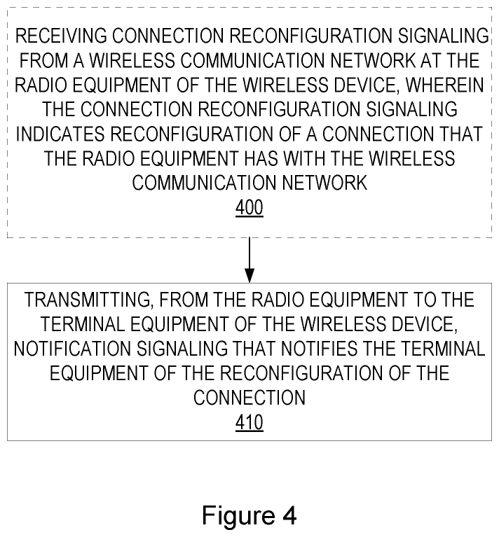

In view of the above modifications and variations, FIG. 4 depicts a method performed by a wireless device 14 that comprises radio equipment 14A and terminal equipment 14B in accordance with other particular embodiments. The method may include receiving connection reconfiguration signaling from a wireless communication network at the radio equipment of the wireless device, wherein the connection reconfiguration signaling indicates reconfiguration of a connection 24 that the radio equipment has with the wireless communication network (Block 400). The method as shown includes transmitting, from the radio equipment to the terminal equipment of the wireless device, notification signaling 26 that notifies the terminal equipment of the reconfiguration of the connection (Block 410).

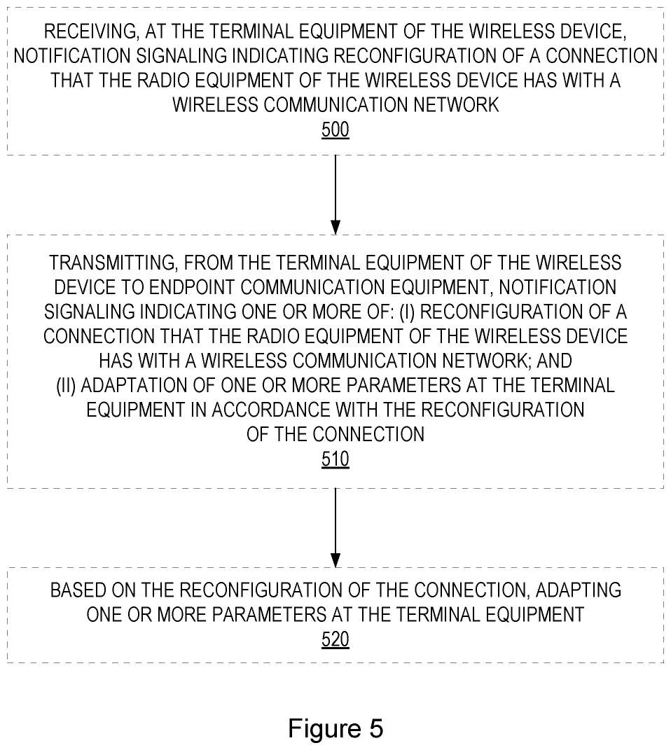

FIG. 5 depicts a method performed by a wireless device 14 that comprises radio equipment 14A and terminal equipment 14B in accordance with other particular embodiments. The method may include receiving, at the terminal equipment of the wireless device, notification signaling (26 or 34) indicating reconfiguration of a connection that the radio equipment of the wireless device has with a wireless communication network (Block 500). The method may alternatively or additionally include transmitting, from the terminal equipment of the wireless device to endpoint communication equipment, notification signaling 28 indicating one or more of: (i) reconfiguration of a connection 24 that the radio equipment of the wireless device has with a wireless communication network; and (ii) adaptation of one or more parameters at the terminal equipment in accordance with the reconfiguration of the connection (Block 510). In some embodiments, the method may include, based on the reconfiguration of the connection, adapting one or more parameters at the terminal equipment (Block 520).

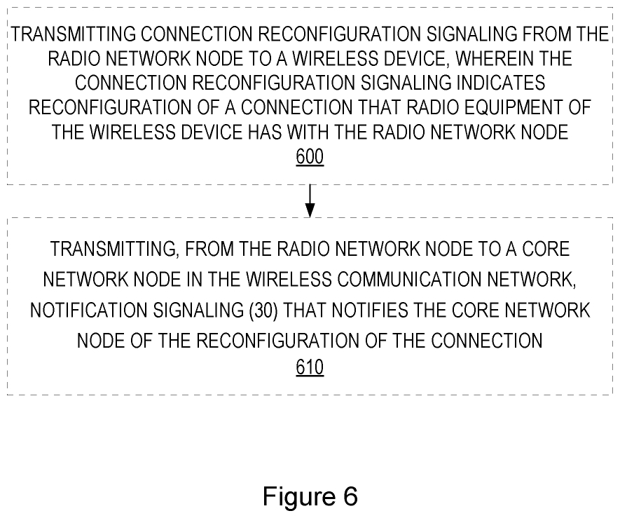

FIG. 6 depicts a method performed by a radio network node 12 configured for use in a wireless communication network 10. The method may include transmitting connection reconfiguration signaling from the radio network node to a wireless device, wherein the connection reconfiguration signaling indicates reconfiguration of a connection 24 that radio equipment of the wireless device has with the radio network node (Block 600). The method may also include transmitting, from the radio network node to a core network node in the wireless communication network, notification signaling 30 that notifies the core network node of the reconfiguration of the connection (Block 610).

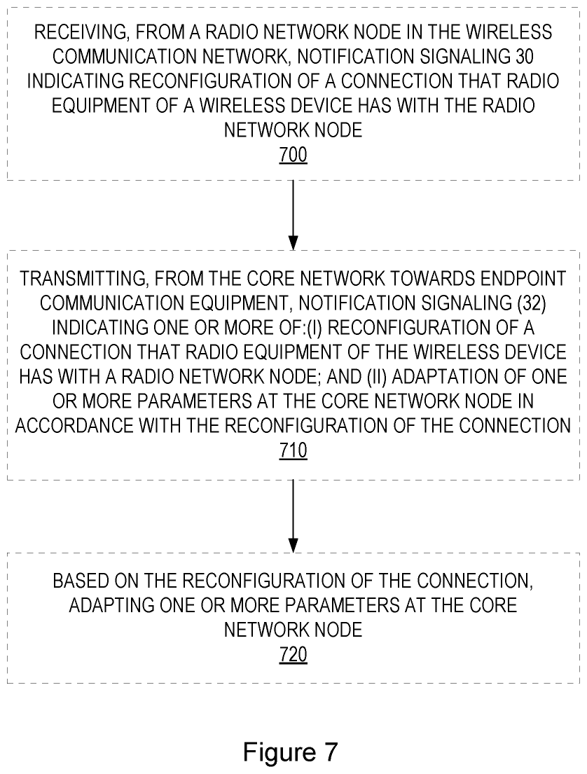

FIG. 7 depicts a method performed by a core network node 18 configured for use in a wireless communication network 10. The method may include receiving, from a radio network node 12 in the wireless communication network, notification signaling 30 indicating reconfiguration of a connection 24 that radio equipment of a wireless device has with the radio network node (Block 700). The method may alternatively or additionally include transmitting, from the core network towards endpoint communication equipment, notification signaling 32 indicating one or more of: (i) reconfiguration of a connection that radio equipment of the wireless device has with a radio network node; and (ii) adaptation of one or more parameters at the core network node in accordance with the reconfiguration of the connection (Block 710). Regardless, the method in some embodiments includes, based on the reconfiguration of the connection, adapting one or more parameters at the core network node (Block 720).

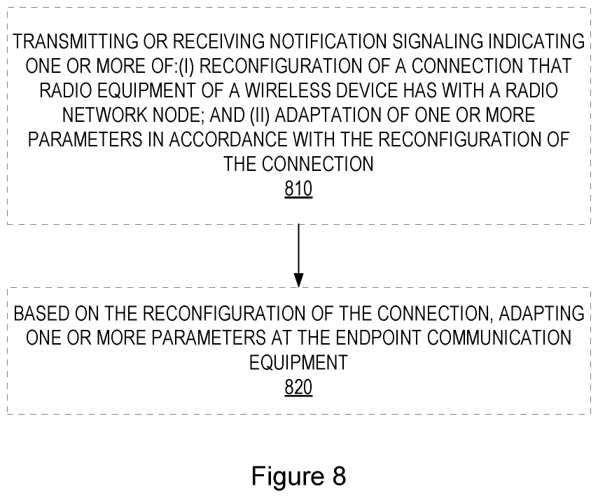

FIG. 8 depicts a method performed by endpoint communication equipment. The method may include transmitting or receiving notification signaling 28 or 34 indicating one or more of: (i) reconfiguration of a connection 24 that radio equipment of a wireless device has with a radio network node; and (ii) adaptation of one or more parameters in accordance with the reconfiguration of the connection (Block 810). The method in some embodiments may include, based on the reconfiguration of the connection, adapting one or more parameters at the endpoint communication equipment (Block 820).

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

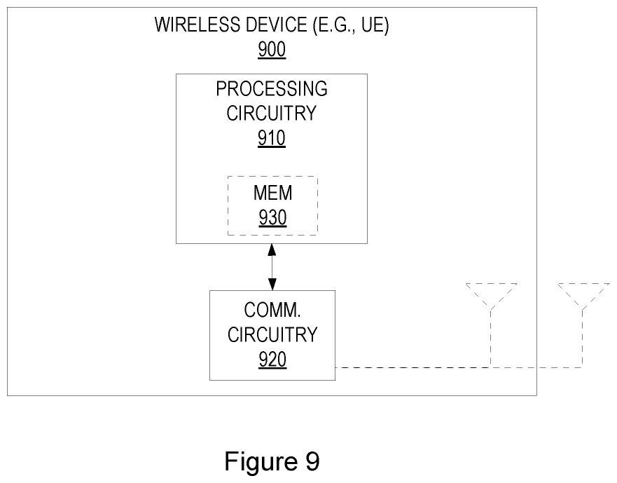

FIG. 9 for example illustrates a wireless device 900 (e.g., wireless device 14, such as a user equipment, UE) as implemented in accordance with one or more embodiments. As shown, the wireless device 900 includes processing circuitry 910 and communication circuitry 920. The communication circuitry 920 (e.g., radio circuitry) is configured to transmit and/or receive information to and/or from one or more other nodes, e.g., via any communication technology. Such communication may occur via one or more antennas that are either internal or external to the wireless device 900. The processing circuitry 910 is configured to perform processing described above, e.g., in FIGS. 4 and/or 5, such as by executing instructions stored in memory 930. The processing circuitry 910 in this regard may implement certain functional means, units, or modules.

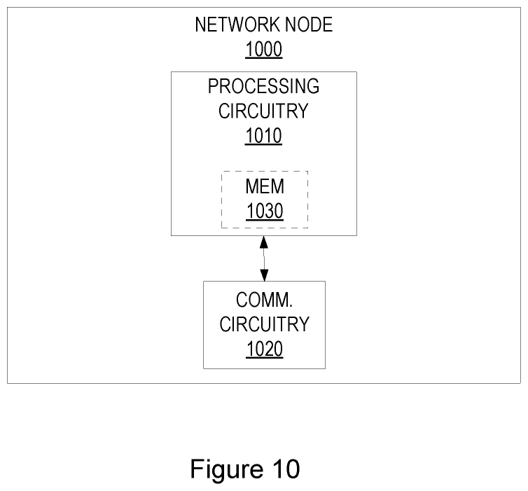

FIG. 10 illustrates a network node 1000 (e.g., radio network node 12 and/or core network node 18) as implemented in accordance with one or more embodiments. As shown, the network node 1000 includes processing circuitry 1010 and communication circuitry 1020. The communication circuitry 1020 is configured to transmit and/or receive information to and/or from one or more other nodes, e.g., via any communication technology. The processing circuitry 1010 is configured to perform processing described above, e.g., in FIGS. 6 and/or 7, such as by executing instructions stored in memory 1030. The processing circuitry 1010 in this regard may implement certain functional means, units, or modules.

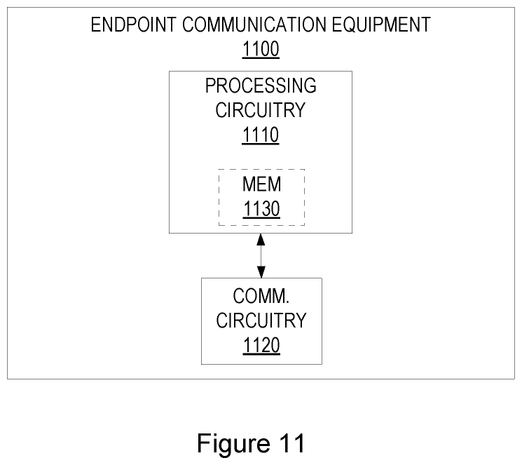

FIG. 11 illustrates endpoint communication equipment 1100 (e.g., endpoint communication equipment 20) as implemented in accordance with one or more embodiments. As shown, the endpoint communication equipment 1100 includes processing circuitry 1110 and communication circuitry 1120. The communication circuitry 1120 is configured to transmit and/or receive information to and/or from one or more other nodes, e.g., via any communication technology. The processing circuitry 1110 is configured to perform processing described above, e.g., in FIG. 8, such as by executing instructions stored in memory 1130. The processing circuitry 1110 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes. For example, in the below discussion, a wireless communication network 10 is exemplified as a mobile network, a wireless device 14 is exemplified as a user equipment (UE), radio equipment 14A of a wireless device is exemplified as a UE modem, terminal equipment 14B of a wireless device is exemplified as UE App(s) or operating system, and an endpoint communication equipment is exemplified as a server. Moreover, reconfiguration of a connection 24 is exemplified as setup or release of a coverage enhancement (CE) mode for the connection 24. But the embodiments are similarly applicable in other contexts and/or wireless network types not explicitly described.

The adaptation of “connection configuration” in mobile networks represents functionality to allow mobile networks and applications to fully exploit a large set of UE capabilities as well as to accommodate variation of such capabilities. In some embodiments, “connection configuration” indicates a series of settings which are supported by both a mobile network and UE modem for control and user plane channels, data transmission/reception, monitoring, etc. Some embodiments focus on the adaptation of such connection configurations, adaptations which are used to better exploit changes in UE/network capabilities (e.g., a change of coverage might involve a configuration change at UE/modem side). In some embodiments, one possible connection configuration is the configuration allowing high-category UEs to adapt the utilization of normal or coverage enhancement (CE) feature in mobile networks.

CE is a mechanism that allows improved coverage by means of using transmission repetitions at control and user plane channels. CE has been introduced as a feature by The 3rd Generation Partnership Project (3GPP) in Long Term Evolution Category M1 (LTE-M) and Narrowband Internet of Things (NB-IoT) to address the coverage requirements of Internet of Things (IoT) use cases, e.g., mainly reports from static sensors located in challenging locations such as basements for low-category UEs (e.g., cat-M1 UEs). Nevertheless, other scenarios might be envisioned where the use of CE is beneficial also for higher UE categories. For instance, considering Vehicle-to-Everything (V2X) services, vehicles might benefit from the utilization of CE when parked in underground parking slots, or when crossing areas with limited connectivity (e.g., long tunnels). This is particularly true in scenarios where vehicles are equipped with Long Term Evolution (LTE) modems, and might work with legacy LTE configuration (i.e., normal coverage, no repetitions) and also with LTE-M configuration of an LTE cell (i.e., CE mode, with repetitions) if the chipset supports the utilization of repetitions. This scenario opens new challenges related to the fact of having high-level UE category (i.e., non-Cat-M1) able to exploit CE mode in addition to the operation in normal coverage. In this case, the utilization of CE in V2X scenarios opens the following challenges:
1. a UE should support the operation in normal coverage (i.e., without the use of repetitions) and in CE mode (i.e., using repetitions);
2. a UE should be able to change the configuration of CE mode utilization (on/off use of CE mode) and the network should be able to configure the utilization of CE mode (i.e., configuring the UE to use/not use CE mode);
3. the UE should be able to configure its behavior according to the utilization of CE mode (e.g., high bandwidth and/or low latency applications should not run when CE mode is used, as quality of service (QoS) cannot be met when using CE mode or because not convenient for the operator to allow huge amount of data traffic when a UE is in CE mode).

Regarding point 1 listed above, several chipset vendors are showing an always increasing interest in manufacturing non-Cat-M1 chipsets with capabilities of supporting CE mode, given the interest shown by car manufactures when it comes to V2X services.

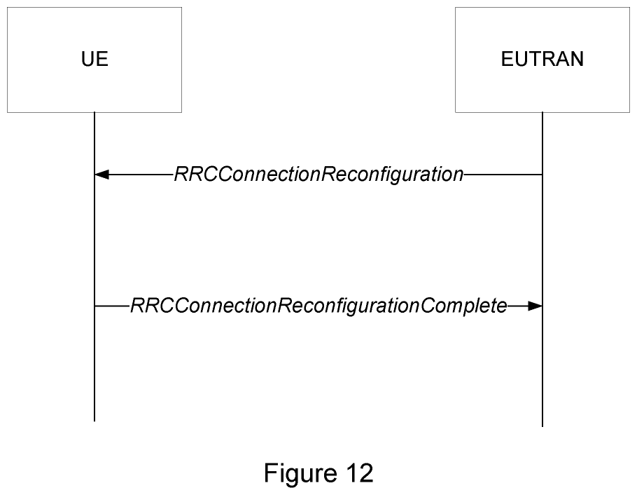

Regarding point 2 listed above, 3GPP introduced the possibility of configuring the utilization of CE mode via the RRCConnectionReconfiguration procedure, defined in TS 36.331, § 5.3.5 (shown in FIG. 12). It will be understood that RRCConnectionReconfiguration can also be referred to as reconfiguration of the radio resource control connection or radio resource control connection reconfiguration.

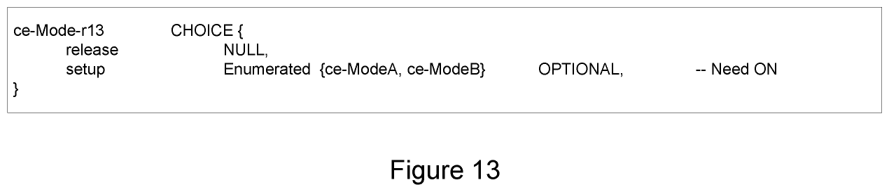

In particular, the RRCConnectionReconfiguration includes the radioResourceConfigDedicated element, which then includes the PhysicalConfigDedicated (defined in TS 36.331, § 6.3.2) element which finally includes the ce-Mode-r13 element. The ce-Mode-r13 element has the structure as shown in FIG. 13, where it can be seen that the network is able to setup the utilization of CE mode (using either CE mode A or CE mode B) or to release the utilization of CE mode.

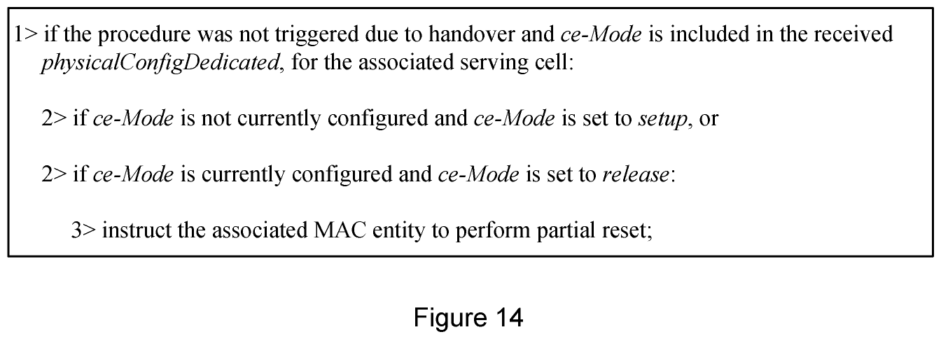

As indicated in TS 36.331, § 5.3.10.6, at the reception of an RRCConnectionReconfiguration message, the UE performs the physical channel reconfiguration as indicated in TS 36.331, § 5.3.10.6 and depicted in FIG. 14, where the UE re-configures the physical channel (thus the utilization of CE mode) according to the content of the CE Mode element.

A proper utilization of CE Mode element in the RRCConnectionReconfiguration can be then used by the network to drive the configuration of using CE mode at the UE.

Regarding point 3 listed above, the adaptation of UE behavior according to CE mode (amount of generated traffic, allowed/disabled applications, etc.) is usually carried in an implementation-specific fashion, with ad-hoc implementations by app developers to check whether a certain application can run according to current available and/or monitored UE modem configuration. Nevertheless, the utilization of CE mode for LTE-M is a specific information relevant to a specific configuration of an LTE cell, information which then resides at UE modem level and might not be available at the operating system and/or application(s).

The possibility of adapting coverage via network-based connection configuration is only one possible configuration change which is of interest for applications/networks. In some embodiments, the adaptation of CE mode utilization is used as an example to help the explanation of the problems associated to connection configuration changes and also to help the explanation of some embodiments. Nevertheless, the problems highlighted with existing solutions as well as CE mode embodiments can be extended other connection configuration in addition to CE mode change.

There currently exist certain challenge(s). A change of connection configuration at the UE modem side might involve a behavior change at the UE App and/or server side in order to optimize data transfer according to variation of UE capabilities. For instance, when a UE is using CE mode, some applications may be disabled as bandwidth hungry or because they require low latency which is not achievable when using CE mode. This requires some sort of information at the operating system and/or applications regarding the particular connection configuration relevant to CE mode utilization. With existing solutions, the re-configuration of connection at the UE modem (e.g., setup/release of CE mode) is not passed at the UE operating system and/or application(s). This means that, while the configuration of the UE modem is supported by 3GPP standard, the adaptation of configuration at the UE application/operating system level is developer-dependent, using ad-hoc solutions to check whether a certain application can run or not according to current modem configuration (using probes to understand if a certain bitrate/latency can be achieved, etc.).

This brings issues in terms of having common solutions adopted by several chipset vendors and/or app developers to take advantage of possibilities of connection reconfigurations (e.g., setup/release CE mode according to UE channel information to avoid loss of connectivity when vehicles move in challenging locations). From a network perspective, this may introduce a limitation regarding the fact that implementing particular connection configuration changes (e.g., CE mode reconfiguration) in a mobile network might be not exploited by customers (such as vehicle OEMs) given the difficulties of having a common framework for exploiting the benefits of dynamic connection configuration.

Certain aspects of the present disclosure and their embodiments may provide solutions to these or other challenges. Some embodiments target the introduction of some functionalities at the UE side, where the UE modem is able to monitor specific changes in the connection configuration (e.g., status of CE mode utilization) and to expose information to the operating system and/or applications when a connection configuration of relevance has happened in order to help proper application adaptation. Alternatively or additionally, the mobile network in some embodiments may be enhanced with functionalities to exploit the information of connection configuration changes in order to allow a behavior adaptation of network policies for traffic treatment.

More particularly, some embodiments introduce functionality at the UE modem which allows the UE modem to filter and monitor some particular changes in the connection configuration (for instance, by monitoring the content of the message of the RRCConnectionReconfiguration procedure), where an example of changes to be monitored is a change in the utilization of CE mode. In some embodiments, this filtering functionality can be up to UE modem implementation or configured by the UE App. Some embodiments also introduce an application programming interface (API) at the UE modem which is used by the UE modem to notify the UE App about a change of connection configuration.

In some embodiments, the information about a change of connection configuration exposed by the UE modem is used by the UE App to adjust its behavior (e.g., limit amount of generated data, enable/disable some applications in case of a setup of CE mode) and to inform the associated end-points of communication about the behavior to be used considering the updated connection configuration at the UE modem.

In some embodiments, the mobile network is extended with functionalities of filtering and monitoring some particular changes in the connection configuration. The mobile network in some embodiments is extended with functionalities of exposure of information about changes of connection configuration, information which are used to adapt core network behavior (e.g., trigger the utilization of specific rate limitation policies according to some specific connection configurations such as the activation of CE mode) or used to provide such information to relevant end-points of communication (e.g., the application function, AF).

Certain embodiments may provide one or more of the following technical advantage(s). Some embodiments introduce capabilities of monitoring specific changes in the connection configuration which are of interest for application adaptation features. This allows operating systems and/or application to be aware of changes of connection configuration at UE modem (e.g., setup/release of CE mode), thus allowing adaptation of their behavior (data generation, etc.) accordingly. For network operators, the solution guarantees that the implementation of mechanisms for connection configuration adaptation can be effectively exploited by UE's applications.

Alternatively or additionally, some embodiments introduce capabilities at the mobile network to expose and exploit information about connection configuration change to adapt the behavior of mobile network (e.g., enforce specific traffic treatment policies) according to particular connection configuration of some UEs of interest.

Consider now the following components which will be discussed in the below embodiments.

The Mobile Network provides connectivity from/to UEs. The mobile network is composed of the radio access network (RAN) and core network. The RAN of the mobile network is assumed to support a variable connection configuration and also supports functionalities to enforce connection (re)configuration at the UE. The mobile network is assumed to be able to identify and authorize specific UEs allowed to perform some specific changes to the connection configuration (e.g., allow a UE to perform a change in the utilization of CE mode). In one example, the mobile network is a fourth generation (4G) system which provides connectivity via LTE radio access technology (RAT), where the LTE RAT supports operation in normal coverage and CE mode. The core network of the mobile system can be either a 4G or a fifth generation (5G) core. In the remainder of this disclosure, a 5G core network is considered, even though embodiments are equally applicable to a 4G core network.

The UE modem provides connectivity for UE App(s) via the mobile network. The UE modem has the capability to support some application programming interfaces (APIs) with the UE App(s) for configuration and information exposure purposes. In some embodiments, the UE modem can be included any non-Cat-M1 UE which also supports the utilization of CE, and which supports the (re)configuration of CE mode utilization from the mobile network.

A UE App generates and/or manages data to be transmitted towards one or more endpoints (and/or receives data from the one or more endpoints) through the UE modem. A UE App may be able to manage the generation of data (enable/disable some specific applications, manage priorities among several traffic flows, etc.). The UE App could be e.g. the operating system of a UE or a software application. In one example for Vehicle-to-Everything (V2X), the UE App could e.g. be the operating system of the UE the vehicle is equipped with which manages several applications (video streaming from vehicle's cameras, vehicle remote control, software updates, sensor reporting, map updates, etc.).

A server represents a possible endpoint for the UE App, e.g., the server generates data to be transmitted to the UE App (and/or receives data from the UE App). The server may be able to manage the generation of data (enable/disable some specific applications, manage priorities among several traffic flows, etc.). In one example regarding V2X services, the server could represent a vehicle's Original Equipment Manufacture (OEM) cloud the UE App is connected to. In another example, the server could be a service provider the UE App is connected to (Google, Here, Spotify, etc.). In another example, the server could be the application function (AF) of a 5G system interacting with a 5G core network, or a service capability server (SCS)/application server (AS) of a 4G system interacting with a 4G core network.

In some embodiments, it is assumed that the mobile network is equipped with a functionality able to understand whether a change of connection configuration should be triggered for a certain UE. The network may check whether one or more decision criteria (or triggering conditions) to adapt its state are met. For example, a network node may determine, based on one or more decision criteria (or triggering conditions), whether to trigger reconfiguration of a connection between a wireless device and the wireless communication network and/or how to reconfigure the connection. In one example, the functionality targets to understand whether there should be a change in the CE mode utilization for a certain UE, where this functionality can be implemented for instance at RAN nodes. In one example, the functionality may consider as inputs (which may also be referred to as decision criteria or triggering conditions) for taking the decision about the change of CE mode the following information:
Current or last reported UE channel information, e.g., reference signal received power (RSRP) or reference signal received quality (RSRQ);
UE channel estimation or prediction, which in some embodiments may be separately or jointly based on one or more external sources such as coverage maps, information about estimated or expected UE trajectory;
Information about UE traffic, such as quality of service (QoS) requirements of ongoing traffic, amount of transferred data, estimation or prediction of upcoming traffic, etc.
UE subscription information, e.g., communicated from core network indicating whether the UE is allowed to perform normal/CE mode switch, UE priority for admission control for normal coverage and CE mode, etc.
Limitations about the configuration change (e.g., configuration change should be performed only in some pre-defined occasions), where such limitations could be provided by the core network and/or be implementation specific at the RAN. For instance, the switch could be limited to happen only in some pre-defined geographical areas and/or time intervals, the switch could be limited to happen only when the UE is expected to be out of normal coverage (or unreachable by means of normal coverage) for a time interval longer than a certain pre-defined value, etc.
UE capabilities, e.g., the UE supporting only CE Mode A or both CE Mode A and Mode B.
RAN load conditions, e.g., number of already admitted UEs using CE Mode, or expected number of UEs.

From the list above, the change of CE mode utilization for a certain UE (and in general the change of connection configuration) can be based on current, historical, estimated or predicted information. In one example, the mobile network utilizes the output of this functionality driving the change of CE mode utilization by enforcing the new CE mode status at the UE modem via the RRCConnectionReconfiguration procedure.

As a specific example, the connection configuration change in some embodiments is triggered by (i) predicted UE behavior, such as the UE being predicted to move in a direction without normal coverage for longer than a certain time interval but with coverage enhancement and/or by (ii) predicted network behavior, where the network predicts that the load for UEs in normal coverage will increase and where some particular UEs for which the traffic is predicted to be low and delay tolerant can be moved to coverage enhancement.

Consider now aspects of the UE side (both UE modem and UE App) in some embodiments.

In one embodiment, functionality implemented at the UE modem is designed to filter the connection configuration received by a mobile network, i.e., to extrapolate from the received configuration those settings which are of importance for the UE as might involve some changes of behavior, and to map such configuration settings of relevance into a set of information which can be then used to verify whether a change of connection configuration has happened.

In one implementation, the filtering of information relevant to the connection configuration is performed after the completion of a RRCConnectionReconfiguration procedure by means of filtering and extrapolating information from the elements of the RRCConnectionReconfiguration message. The filtering can be performed according to some proprietary configurations of the UE modem (e.g., the vendor of the UE modem provides a pre-defined filtering capabilities tailored for specific verticals e.g. automotive/V2X services) or the UE modem supports some APIs allowing the UE App to explicit configure the filtering (e.g., a V2X UE App requires the filtering of specific configuration settings and the UE modem provides a feedback whether such filtering capability is supported or not) in order to allow that the filtering configuration can be adapted according to some specific needs of e.g. V2X services. In one example, the UE modem may be configured by design or upon request by the UE App to filter the connection configuration received by the mobile network with the aim to extrapolate information about the status of utilization of CE mode. To this aim, in one implementation, the UE modem keeps an indicator monitoring the status of utilization of the CE mode, where examples of the status are: not used (CE mode has never been used); setup (CE mode is currently used, with potentially also additional information about which CE mode has been setup, i.e., Mode A or Mode B); release (CE mode was used before but now it is not used anymore). In some embodiments, the UE modem checks whether there is a change in the status of CE mode utilization upon completion of a RRCConnectionReconfiguration procedure. Example of changes of the status of utilization of CE mode are: (i) not used->setup, which is the case when the CE mode has not been used and the UE modem receives an indication from the network to use the CE mode; (ii) setup->release, which is the case when the CE mode has been activated previously and it is currently used, and the UE modem receives an indication from the network to release the utilization of the CE mode; and (iii) release->setup, which is the case when the CE mode has been released previously and it is currently not used, and the UE modem receives an indication from the network to use the CE mode.

In some embodiments, the change of CE mode status is associated to the reception by the UE modem of a RRCConnectionReconfiguration, wherein the CE-Mode element can be set by the network to “setup” (and in this case, it can be set to “Mode A” or “Mode B”) or “release” (the CE-Mode element is included in the PhysicalConfigDedicated element included in the radioResourceConfigDedicated element of the RRCConnectionReconfiguration message). At the reception of the RRCConnectionReconfiguration, the UE modem checks whether the modem can be re-configured according to the configuration indicated by the network and, if so, the UE modem replies with a RRCConnectionReconfigurationComplete message. When replying with the RRCConnectionReconfigurationComplete, the UE modem is then aware whether the status of CE mode has been updated (i.e., the UE modem is going to use a new configuration for CE mode with respect to the previous used configuration).

In another embodiment, the UE modem implements an API that allows the UE modem to inform another entity about a change in the connection configuration.

In one implementation, the UE modem implements an API “connectionConfigurationChange” (or application programming interface connection configuration change) that can be used to expose towards another entity the information that the connection configuration has been changed, also containing additional information relevant to which settings have been changed. Such exposure of information is beneficial to support the adaptation of behavior according to connection configuration changes. In one example, the “connectionConfigurationChange” API might be used by the UE modem to notify a receiver of interest about a change in the utilization of CE mode, for instance to notify that CE mode has been setup at the UE modem with potentially additional information (e.g., setup with Mode A or Mode B).

In another embodiment, the UE App receives a notification from the UE modem which contains information regarding a change in the connection configuration at the UE modem. The notification in some embodiments may also contain additional information relevant to which settings have been changed. In one implementation, a V2X UE App supports an API “connectionConfigurationChange” used by the UE modem to expose information about a connection configuration change, thus allowing the UE App to receive a notification regarding changes in the connection configuration (e.g., setup or release of CE mode) at the UE modem.

In another embodiment, the UE App utilizes the information exposed by the UE modem (i) to adapt the behavior of data generation and/or data transfer according to the particular connection configuration used at the UE modem and, if necessary, (ii) to inform the relevant end-point(s) (e.g., a server) of communication about such behavior change. In one example regarding V2X services, data communication has two different behaviors associated to the utilization at the UE modem of the CE mode: (i) one related to when the UE modem is configured to use normal coverage (for instance, the behavior allows applications with high bitrates, low latency, and huge file transfer such as video streaming, remote control, software updates, massive sensor reporting, etc.); (ii) one related to when the UE modem is configured to use CE (for instance, the behavior does not allow applications with high bitrates, low latency, and huge file transfer but allows only small data transfer with delay tolerant profiles such as basic sensor reports, etc.). In one implementation, a V2X UE App adapts its behavior according to the body of the message “connectionConfigurationChange” received by the UE modem. At the reception of a “connectionConfigurationChange” message from the UE modem, the UE App configures its behavior according to the fact that the CE mode has been setup/released at the UE modem. For instance, the UE App enables/disables some applications, and informs the endpoints (e.g., server) about such change so that the same behavior is used also at the other side of communication. This is used to avoid that, e.g., the UE App and/or the server steer high volume of traffic or traffic with strict QoS requirements when the UE modem is using CE mode. For instance, in a V2X scenario, this avoids that complex applications such as tele-operated driving are triggered when a vehicle-mounted UE is configured to use CE mode. In another implementation, any endpoint of the communication sends a notification to the other endpoint(s) whenever a behavior change is triggered.

Consider now the network side.

In one embodiment, the mobile network implements a functionality designed to filter the connection configuration enforced for a certain UE, i.e., to extrapolate from the connection configuration those configuration settings which are of relevance and to map such configuration relevant settings into a set of information which can be then used to verify whether a change of connection configuration has happened.

In one implementation, the filtering of information is implemented at the RAN of a mobile network, where the filtering may be designed by some specific needs of some verticals or services (e.g., V2X). The filtering may be performed after the completion of a RRCConnectionReconfiguration procedure by means of filtering and extrapolating information from the elements of the RRCConnectionReconfiguration message. The filtering can be performed according to some proprietary configurations of the RAN (e.g., the RAN vendor provides a pre-defined capabilities of filtering) or the RAN supports some APIs allowing the core network and/or the OAM and/or the AF (via the 5G core) to explicit configure the filtering (e.g., a specific filtering of configuration settings is required and the RAN provides a feedback whether such filtering capability is supported or not) as well as for which UEs such filtering should be performed. In one example considering V2X services, the RAN may be configured by design or upon request to filter the connection configuration with the aim to extrapolate information about the status of utilization of CE mode for one UE or a subset of UEs, in order to obtain the information whether the utilization of CE mode for a certain UE has been changed or not.

In another embodiment, the mobile network implements some signaling to expose the information about a change of connection configuration for a certain UE (or group of UEs) to relevant receiver(s). In one implementation, this functionality is implemented at the RAN and it is used to inform one or more core network functions (e.g., access and mobility management function (AMF), session management function (SMF), policy control function (PCF)) about a change of connection configuration for a certain UE (e.g., setup/release of CE mode for the case of V2X services). For instance, the RAN can be configured to expose only a particular set of changes (i.e., not all changes of connection configuration that happen at the RAN are exposed) and the RAN can be configured to expose the information of the connection configuration change to different network functions, e.g., the information of the connection configuration change with regards to the CE mode change has to be exposed to the SMF, while the information of the connection configuration change with regards to another type of change has to be exposed to the PCF. In one example of implementation, the RAN exposes the information about a connection configuration change by using some signaling “RANConnectionConfigurationChange” towards one or more core network functions. This signaling may be sent from the RAN towards relevant core network functions (e.g., AMF, SMF, PCF) and contains information such as UE identity or identities (I D(s)) for which the connection configuration has changed as well as additional information regarding the change itself (e.g., setup/release of CE mode A or CE mode B).

In another embodiment, the mobile network implements some signaling to expose the information about a change of connection configuration for a certain UE (or group of UEs) to an AF of relevance for the UE(s) to which the connection configuration change refers. In one example, the information about a change of connection configuration which is exposed from the RAN towards the core network functions such as the PCF, is exposed to an AF. The exposure of such information directly in case of a trusted AF, or via the network exposure function (NEF) in case of an untrusted AF. The exposure of such information from the core network functions to the AF may also be performed with additional information filtering (e.g., parts of the information available at the core network functions are filtered and not forwarded to the AF, or only some particular notifications available at the core network functions are exposed towards the AF) or without any further modification. This allows the AF to be aware that there has been a connection configuration change for one or more UE(s). The availability of such information at the AF allows the AF to make aware the service about the change of connection configuration, which then allows the server to adapt its behavior according to the connection configuration change and, if necessary, to inform the UE App regarding this change of behavior.

In another embodiment, the mobile network implements a functionality to adapt its behavior according to the exposed information about a change of connection configuration for a certain UE (or group of UEs). In one example of implementation considering a mobile network which implements V2X-specific adaptation capabilities according to CE mode utilization, the Access and Mobility Function (AMF), the Session Management Function (SMF), or the Policy Control Function (PCF), after the reception of an information regarding the connection configuration change for a UE which changed CE mode utilization (e.g., a setup of CE mode), triggers a behavior adaptation at the network nodes (e.g., User Plane Function, UPF) for the traffic associated to the UE(s) of interest. To this aim, the information about the change of connection configuration which is received by a network function (e.g., AMF) can be further exposed to other relevant network functions (e.g., SMF, PCF) which are involved in the adaptation. An example of adaptation is for instance triggering the utilization of specific policies to adapt the behavior of the network to the connection configuration change. An example of specific policies include bitrate limitation functionality for the UE once CE mode has been setup, or change of UE/traffic priority, or change of charging, etc. In another example, the SMF or the PCF, upon reception of a notification that the CE mode has been released for a UE, triggers a behavior adaptation at the UPF for the traffic associated to the UE of interest by removing the bitrate limitation (or any other configuration relevant to CE mode) valid when the UE had CE mode active.

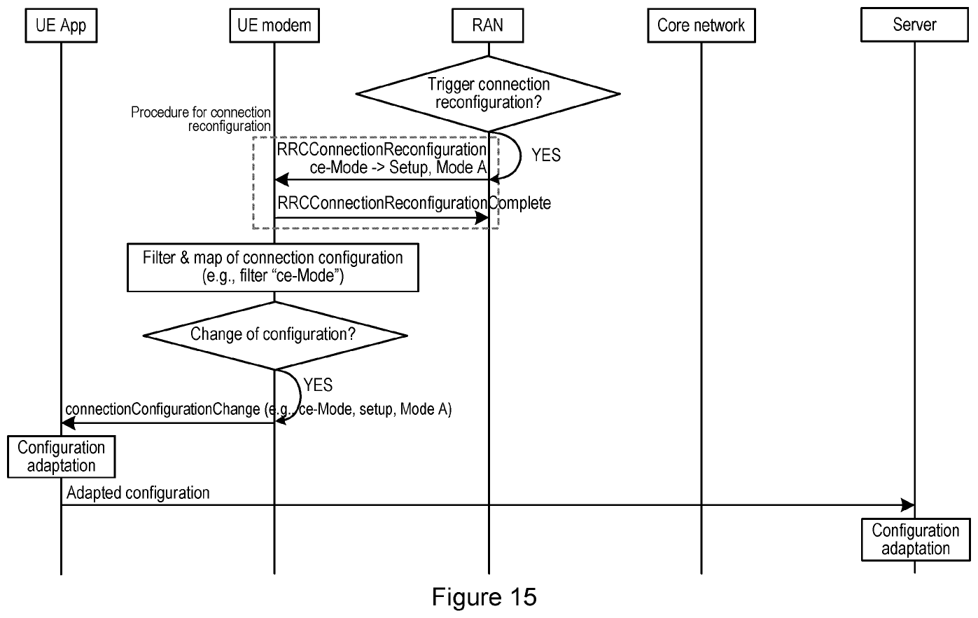

An example illustrating some embodiments with focus on the UE side can be found in FIG. 15, where the interest of the connection configuration change is relevant to the change of CE mode utilization. In particular, the example depicts a change of the connection configuration from a status where CE mode is not used to a status where CE Mode A is going to be utilized. FIG. 15 highlights the functionality added in the mobile network to check whether a change from normal coverage to CE Mode is needed for a certain UE. FIG. 15 in this regard highlights embodiments including: (i) the functionality added at the UE modem to check the change of connection configuration (CE mode status in this case); (ii) The functionality added at the UE modem to expose such information to the UE App; and (iii) The functionality added at the UE App to adjust its behavior according to the information about the CE mode change exposed from the UE modem, and to accordingly inform the server about the behavior update.

The flow diagram in FIG. 15 can be extended to consider other types of changes, e.g., from setup to release of CE mode, or also to consider additional connection configuration changes.

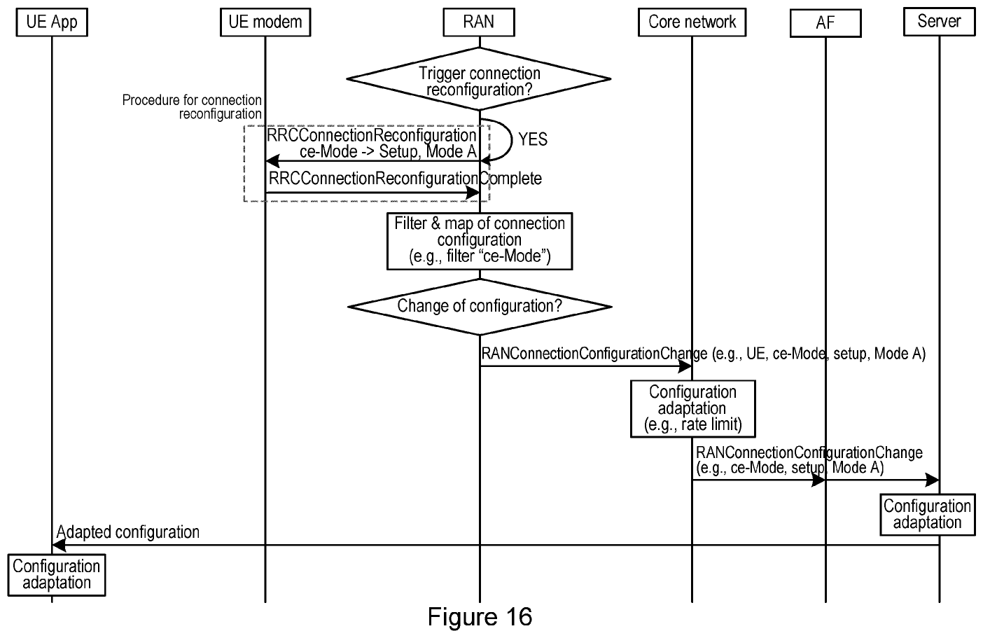

An example illustrating other embodiments with focus on the mobile network side can be found in FIG. 16, where the interest of the connection configuration change is relevant to the change of CE mode utilization. In particular, the example depicts a change of the connection configuration from a status where CE mode is not used to a status where CE Mode A is going to be utilized. FIG. 16 highlights the functionality added in the mobile network to check whether a change from normal coverage to CE Mode is needed for a certain UE. FIG. 16 in this regard highlights embodiments including: (i) The functionality added at the RAN to check the change of connection configuration (CE mode status in this case); (ii) The functionality added at the RAN to expose such information to the core network; (iii) The functionality added at the core network to adjust its behavior according to the information about the CE mode change exposed from the RAN; and (iv) The functionality added at the core network to accordingly inform the AF about the connection configuration update, after which the AF then informs the Server about the connection configuration update and the server then decides to adapt its behavior according to the connection configuration change and informs the UE App of such behavior change.

The flow diagram in FIG. 16 can be extended to consider other types of changes, e.g., from setup to release of CE mode, or also to consider additional connection configuration changes.

The two sides of the embodiments shown above (i.e., the UE and mobile network, shown in FIGS. 15 and 16 respectively) can be implemented independently. Changes at the UE side can be implemented regardless of the changes implemented at the mobile network. Or, the two sides of the embodiments can be both implemented jointly, i.e., simultaneously. Please note that the configuration of filtering rules at UE and network sides can be used.

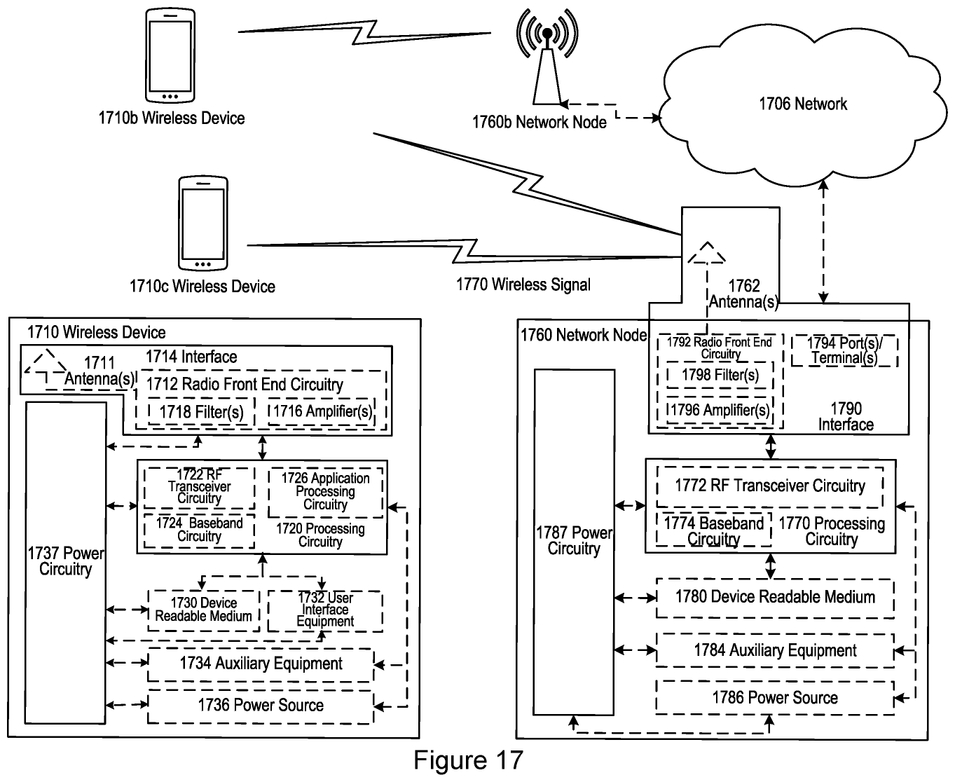

Although the subject matter described herein may be implemented in any appropriate type of system using any suitable components, the embodiments disclosed herein are described in relation to a wireless network, such as the example wireless network illustrated in FIG. 17. For simplicity, the wireless network of FIG. 17 only depicts network 1706, network nodes 1760 and 1760b, and wireless devices (WDs) 1710, 1710b, and 1710c. In practice, a wireless network may further include any additional elements suitable to support communication between wireless devices or between a wireless device and another communication device, such as a landline telephone, a service provider, or any other network node or end device. Of the illustrated components, network node 1760 and wireless device (WD) 1710 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1760 and WD 1710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SM LCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 17, network node 1760 includes processing circuitry 1770, device readable medium 1780, interface 1790, auxiliary equipment 1784, power source 1786, power circuitry 1787, and antenna 1762. Although network node 1760 illustrated in the example wireless network of FIG. 17 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1760 are depicted as single boxes located within a larger box, or nested within multiple boxes, in practice, a network node may comprise multiple different physical components that make up a single illustrated component (e.g., device readable medium 1780 may comprise multiple separate hard drives as well as multiple RAM modules).

Similarly, network node 1760 may be composed of multiple physically separate components (e.g., a NodeB component and a RNC component, or a BTS component and a BSC component, etc.), which may each have their own respective components. In certain scenarios in which network node 1760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1760 may be configured to support multiple radio access technologies (RATs). In such embodiments, some components may be duplicated (e.g., separate device readable medium 1780 for the different RATs) and some components may be reused (e.g., the same antenna 1762 may be shared by the RATs). Network node 1760 may also include multiple sets of the various illustrated components for different wireless technologies integrated into network node 1760, such as, for example, GSM, WCDMA, LTE, NR, WiFi, or Bluetooth wireless technologies. These wireless technologies may be integrated into the same or different chip or set of chips and other components within network node 1760.

Processing circuitry 1770 is configured to perform any determining, calculating, or similar operations (e.g., certain obtaining operations) described herein as being provided by a network node. These operations performed by processing circuitry 1770 may include processing information obtained by processing circuitry 1770 by, for example, converting the obtained information into other information, comparing the obtained information or converted information to information stored in the network node, and/or performing one or more operations based on the obtained information or converted information, and as a result of said processing making a determination.

Processing circuitry 1770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1760 components, such as device readable medium 1780, network node 1760 functionality. For example, processing circuitry 1770 may execute instructions stored in device readable medium 1780 or in memory within processing circuitry 1770. Such functionality may include providing any of the various wireless features, functions, or benefits discussed herein. In some embodiments, processing circuitry 1770 may include a system on a chip (SOC).

In some embodiments, processing circuitry 1770 may include one or more of radio frequency (RF) transceiver circuitry 1772 and baseband processing circuitry 1774. In some embodiments, radio frequency (RF) transceiver circuitry 1772 and baseband processing circuitry 1774 may be on separate chips (or sets of chips), boards, or units, such as radio units and digital units. In alternative embodiments, part or all of RF transceiver circuitry 1772 and baseband processing circuitry 1774 may be on the same chip or set of chips, boards, or units

In certain embodiments, some or all of the functionality described herein as being provided by a network node, base station, eNB or other such network device may be performed by processing circuitry 1770 executing instructions stored on device readable medium 1780 or memory within processing circuitry 1770. In alternative embodiments, some or all of the functionality may be provided by processing circuitry 1770 without executing instructions stored on a separate or discrete device readable medium, such as in a hard-wired manner. In any of those embodiments, whether executing instructions stored on a device readable storage medium or not, processing circuitry 1770 can be configured to perform the described functionality. The benefits provided by such functionality are not limited to processing circuitry 1770 alone or to other components of network node 1760, but are enjoyed by network node 1760 as a whole, and/or by end users and the wireless network generally.

Device readable medium 1780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1770. Device readable medium 1780 may store any suitable instructions, data or information, including a computer program, software, an application including one or more of logic, rules, code, tables, etc. and/or other instructions capable of being executed by processing circuitry 1770 and, utilized by network node 1760. Device readable medium 1780 may be used to store any calculations made by processing circuitry 1770 and/or any data received via interface 1790. In some embodiments, processing circuitry 1770 and device readable medium 1780 may be considered to be integrated.

Interface 1790 is used in the wired or wireless communication of signalling and/or data between network node 1760, network 1706, and/or WDs 1710. As illustrated, interface 1790 comprises port(s)/terminal(s) 1794 to send and receive data, for example to and from network 1706 over a wired connection. Interface 1790 also includes radio front end circuitry 1792 that may be coupled to, or in certain embodiments a part of, antenna 1762. Radio front end circuitry 1792 comprises filters 1798 and amplifiers 1796. Radio front end circuitry 1792 may be connected to antenna 1762 and processing circuitry 1770. Radio front end circuitry may be configured to condition signals communicated between antenna 1762 and processing circuitry 1770. Radio front end circuitry 1792 may receive digital data that is to be sent out to other network nodes or WDs via a wireless connection. Radio front end circuitry 1792 may convert the digital data into a radio signal having the appropriate channel and bandwidth parameters using a combination of filters 1798 and/or amplifiers 1796. The radio signal may then be transmitted via antenna 1762. Similarly, when receiving data, antenna 1762 may collect radio signals which are then converted into digital data by radio front end circuitry 1792. The digital data may be passed to processing circuitry 1770. In other embodiments, the interface may comprise different components and/or different combinations of components.

In certain alternative embodiments, network node 1760 may not include separate radio front end circuitry 1792, instead, processing circuitry 1770 may comprise radio front end circuitry and may be connected to antenna 1762 without separate radio front end circuitry 1792. Similarly, in some embodiments, all or some of RF transceiver circuitry 1772 may be considered a part of interface 1790. In still other embodiments, interface 1790 may include one or more ports or terminals 1794, radio front end circuitry 1792, and RF transceiver circuitry 1772, as part of a radio unit (not shown), and interface 1790 may communicate with baseband processing circuitry 1774, which is part of a digital unit (not shown).

Antenna 1762 may include one or more antennas, or antenna arrays, configured to send and/or receive wireless signals. Antenna 1762 may be coupled to radio front end circuitry 1790 and may be any type of antenna capable of transmitting and receiving data and/or signals wirelessly. In some embodiments, antenna 1762 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1762 may be separate from network node 1760 and may be connectable to network node 1760 through an interface or port.

Antenna 1762, interface 1790, and/or processing circuitry 1770 may be configured to perform any receiving operations and/or certain obtaining operations described herein as being performed by a network node. Any information, data and/or signals may be received from a wireless device, another network node and/or any other network equipment. Similarly, antenna 1762, interface 1790, and/or processing circuitry 1770 may be configured to perform any transmitting operations described herein as being performed by a network node. Any information, data and/or signals may be transmitted to a wireless device, another network node and/or any other network equipment.

Power circuitry 1787 may comprise, or be coupled to, power management circuitry and is configured to supply the components of network node 1760 with power for performing the functionality described herein. Power circuitry 1787 may receive power from power source 1786. Power source 1786 and/or power circuitry 1787 may be configured to provide power to the various components of network node 1760 in a form suitable for the respective components (e.g., at a voltage and current level needed for each respective component). Power source 1786 may either be included in, or external to, power circuitry 1787 and/or network node 1760. For example, network node 1760 may be connectable to an external power source (e.g., an electricity outlet) via an input circuitry or interface such as an electrical cable, whereby the external power source supplies power to power circuitry 1787. As a further example, power source 1786 may comprise a source of power in the form of a battery or battery pack which is connected to, or integrated in, power circuitry 1787. The battery may provide backup power should the external power source fail. Other types of power sources, such as photovoltaic devices, may also be used.

Alternative embodiments of network node 1760 may include additional components beyond those shown in FIG. 17 that may be responsible for providing certain aspects of the network node's functionality, including any of the functionality described herein and/or any functionality necessary to support the subject matter described herein. For example, network node 1760 may include user interface equipment to allow input of information into network node 1760 and to allow output of information from network node 1760. This may allow a user to perform diagnostic, maintenance, repair, and other administrative functions for network node 1760.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (Vol P) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1710 includes antenna 1711, interface 1714, processing circuitry 1720, device readable medium 1730, user interface equipment 1732, auxiliary equipment 1734, power source 1736 and power circuitry 1737. WD 1710 may include multiple sets of one or more of the illustrated components for different wireless technologies supported by WD 1710, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1710.

Antenna 1711 may include one or more antennas or antenna arrays, configured to send and/or receive wireless signals, and is connected to interface 1714. In certain alternative embodiments, antenna 1711 may be separate from WD 1710 and be connectable to WD 1710 through an interface or port. Antenna 1711, interface 1714, and/or processing circuitry 1720 may be configured to perform any receiving or transmitting operations described herein as being performed by a WD. Any information, data and/or signals may be received from a network node and/or another WD. In some embodiments, radio front end circuitry and/or antenna 1711 may be considered an interface.

As illustrated, interface 1714 comprises radio front end circuitry 1712 and antenna 1711. Radio front end circuitry 1712 comprise one or more filters 1718 and amplifiers 1716. Radio front end circuitry 1714 is connected to antenna 1711 and processing circuitry 1720, and is configured to condition signals communicated between antenna 1711 and processing circuitry 1720. Radio front end circuitry 1712 may be coupled to or a part of antenna 1711. In some embodiments, WD 1710 may not include separate radio front end circuitry 1712; rather, processing circuitry 1720 may comprise radio front end circuitry and may be connected to antenna 1711. Similarly, in some embodiments, some or all of RF transceiver circuitry 1722 may be considered a part of interface 1714. Radio front end circuitry 1712 may receive digital data that is to be sent out to other network nodes or WDs via a wireless connection. Radio front end circuitry 1712 may convert the digital data into a radio signal having the appropriate channel and bandwidth parameters using a combination of filters 1718 and/or amplifiers 1716. The radio signal may then be transmitted via antenna 1711. Similarly, when receiving data, antenna 1711 may collect radio signals which are then converted into digital data by radio front end circuitry 1712. The digital data may be passed to processing circuitry 1720. In other embodiments, the interface may comprise different components and/or different combinations of components.

Processing circuitry 1720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1710 components, such as device readable medium 1730, WD 1710 functionality. Such functionality may include providing any of the various wireless features or benefits discussed herein. For example, processing circuitry 1720 may execute instructions stored in device readable medium 1730 or in memory within processing circuitry 1720 to provide the functionality disclosed herein.

As illustrated, processing circuitry 1720 includes one or more of RF transceiver circuitry 1722, baseband processing circuitry 1724, and application processing circuitry 1726. In other embodiments, the processing circuitry may comprise different components and/or different combinations of components. In certain embodiments processing circuitry 1720 of WD 1710 may comprise a SOC. In some embodiments, RF transceiver circuitry 1722, baseband processing circuitry 1724, and application processing circuitry 1726 may be on separate chips or sets of chips. In alternative embodiments, part or all of baseband processing circuitry 1724 and application processing circuitry 1726 may be combined into one chip or set of chips, and RF transceiver circuitry 1722 may be on a separate chip or set of chips. In still alternative embodiments, part or all of RF transceiver circuitry 1722 and baseband processing circuitry 1724 may be on the same chip or set of chips, and application processing circuitry 1726 may be on a separate chip or set of chips. In yet other alternative embodiments, part or all of RF transceiver circuitry 1722, baseband processing circuitry 1724, and application processing circuitry 1726 may be combined in the same chip or set of chips. In some embodiments, RF transceiver circuitry 1722 may be a part of interface 1714. RF transceiver circuitry 1722 may condition RF signals for processing circuitry 1720.

In certain embodiments, some or all of the functionality described herein as being performed by a WD may be provided by processing circuitry 1720 executing instructions stored on device readable medium 1730, which in certain embodiments may be a computer-readable storage medium. In alternative embodiments, some or all of the functionality may be provided by processing circuitry 1720 without executing instructions stored on a separate or discrete device readable storage medium, such as in a hard-wired manner. In any of those particular embodiments, whether executing instructions stored on a device readable storage medium or not, processing circuitry 1720 can be configured to perform the described functionality. The benefits provided by such functionality are not limited to processing circuitry 1720 alone or to other components of WD 1710, but are enjoyed by WD 1710 as a whole, and/or by end users and the wireless network generally.

Processing circuitry 1720 may be configured to perform any determining, calculating, or similar operations (e.g., certain obtaining operations) described herein as being performed by a WD. These operations, as performed by processing circuitry 1720, may include processing information obtained by processing circuitry 1720 by, for example, converting the obtained information into other information, comparing the obtained information or converted information to information stored by WD 1710, and/or performing one or more operations based on the obtained information or converted information, and as a result of said processing making a determination.

Device readable medium 1730 may be operable to store a computer program, software, an application including one or more of logic, rules, code, tables, etc. and/or other instructions capable of being executed by processing circuitry 1720. Device readable medium 1730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1720. In some embodiments, processing circuitry 1720 and device readable medium 1730 may be considered to be integrated.

User interface equipment 1732 may provide components that allow for a human user to interact with WD 1710. Such interaction may be of many forms, such as visual, audial, tactile, etc. User interface equipment 1732 may be operable to produce output to the user and to allow the user to provide input to WD 1710. The type of interaction may vary depending on the type of user interface equipment 1732 installed in WD 1710. For example, if WD 1710 is a smart phone, the interaction may be via a touch screen; if WD 1710 is a smart meter, the interaction may be through a screen that provides usage (e.g., the number of gallons used) or a speaker that provides an audible alert (e.g., if smoke is detected). User interface equipment 1732 may include input interfaces, devices and circuits, and output interfaces, devices and circuits. User interface equipment 1732 is configured to allow input of information into WD 1710, and is connected to processing circuitry 1720 to allow processing circuitry 1720 to process the input information. User interface equipment 1732 may include, for example, a microphone, a proximity or other sensor, keys/buttons, a touch display, one or more cameras, a USB port, or other input circuitry. User interface equipment 1732 is also configured to allow output of information from WD 1710, and to allow processing circuitry 1720 to output information from WD 1710. User interface equipment 1732 may include, for example, a speaker, a display, vibrating circuitry, a USB port, a headphone interface, or other output circuitry. Using one or more input and output interfaces, devices, and circuits, of user interface equipment 1732, WD 1710 may communicate with end users and/or the wireless network, and allow them to benefit from the functionality described herein.

Auxiliary equipment 1734 is operable to provide more specific functionality which may not be generally performed by WDs. This may comprise specialized sensors for doing measurements for various purposes, interfaces for additional types of communication such as wired communications etc. The inclusion and type of components of auxiliary equipment 1734 may vary depending on the embodiment and/or scenario.

Power source 1736 may, in some embodiments, be in the form of a battery or battery pack. Other types of power sources, such as an external power source (e.g., an electricity outlet), photovoltaic devices or power cells, may also be used. WD 1710 may further comprise power circuitry 1737 for delivering power from power source 1736 to the various parts of WD 1710 which need power from power source 1736 to carry out any functionality described or indicated herein. Power circuitry 1737 may in certain embodiments comprise power management circuitry. Power circuitry 1737 may additionally or alternatively be operable to receive power from an external power source; in which case WD 1710 may be connectable to the external power source (such as an electricity outlet) via input circuitry or an interface such as an electrical power cable. Power circuitry 1737 may also in certain embodiments be operable to deliver power from an external power source to power source 1736. This may be, for example, for the charging of power source 1736. Power circuitry 1737 may perform any formatting, converting, or other modification to the power from power source 1736 to make the power suitable for the respective components of WD 1710 to which power is supplied.

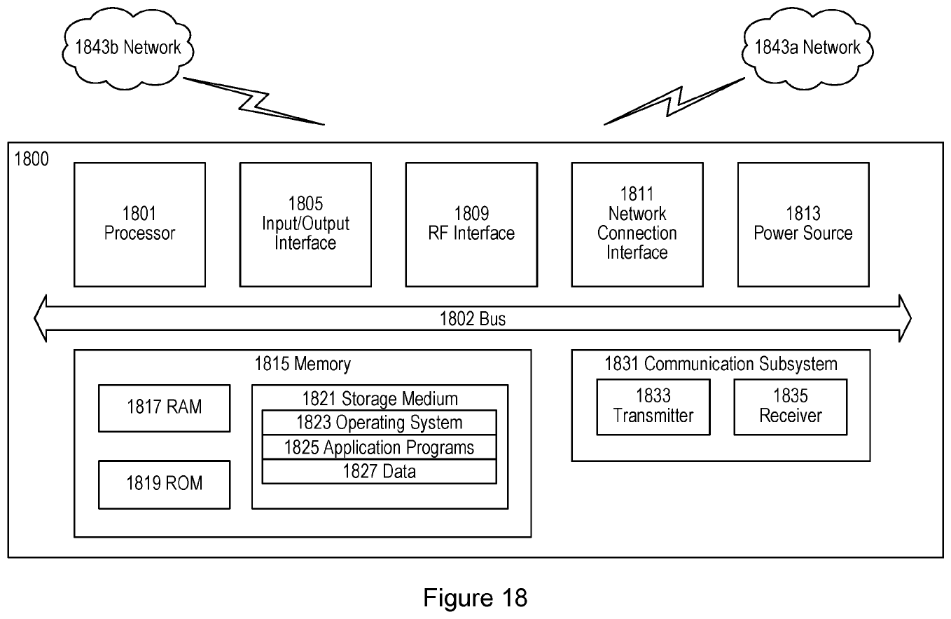

FIG. 18 illustrates one embodiment of a wireless device, e.g. UE, in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 18200 may be any UE identified by the 3^{rd} Generation Partnership Project (3GPP), including a NB-IoT UE, a machine type communication (MTC) UE, and/or an enhanced MTC (eMTC) UE. UE 1800, as illustrated in FIG. 18, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 18 is a UE, the components discussed herein are equally applicable to a WD, and vice-versa.

In FIG. 18, UE 1800 includes processing circuitry 1801 that is operatively coupled to input/output interface 1805, radio frequency (RF) interface 1809, network connection interface 1811, memory 1815 including random access memory (RAM) 1817, read-only memory (ROM) 1819, and storage medium 1821 or the like, communication subsystem 1831, power source 1833, and/or any other component, or any combination thereof. Storage medium 1821 includes operating system 1823, application program 1825, and data 1827. In other embodiments, storage medium 1821 may include other similar types of information. Certain UEs may utilize all of the components shown in FIG. 18, or only a subset of the components. The level of integration between the components may vary from one UE to another UE. Further, certain UEs may contain multiple instances of a component, such as multiple processors, memories, transceivers, transmitters, receivers, etc.

In FIG. 18, processing circuitry 1801 may be configured to process computer instructions and data. Processing circuitry 1801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1801 may include two central processing units (CPUs). Data may be information in a form suitable for use by a computer.

In the depicted embodiment, input/output interface 1805 may be configured to provide a communication interface to an input device, output device, or input and output device. UE 1800 may be configured to use an output device via input/output interface 1805. An output device may use the same type of interface port as an input device. For example, a USB port may be used to provide input to and output from UE 1800. The output device may be a speaker, a sound card, a video card, a display, a monitor, a printer, an actuator, an emitter, a smartcard, another output device, or any combination thereof. UE 1800 may be configured to use an input device via input/output interface 1805 to allow a user to capture information into UE 1800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 18, RF interface 1809 may be configured to provide a communication interface to RF components such as a transmitter, a receiver, and an antenna. Network connection interface 1811 may be configured to provide a communication interface to network 1843a. Network 1843a may encompass wired and/or wireless networks such as a local-area network (LAN), a wide-area network (WAN), a computer network, a wireless network, a telecommunications network, another like network or any combination thereof. For example, network 1843a may comprise a Wi-Fi network. Network connection interface 1811 may be configured to include a receiver and a transmitter interface used to communicate with one or more other devices over a communication network according to one or more communication protocols, such as Ethernet, TCP/IP, SONET, ATM, or the like. Network connection interface 1811 may implement receiver and transmitter functionality appropriate to the communication network links (e.g., optical, electrical, and the like). The transmitter and receiver functions may share circuit components, software or firmware, or alternatively may be implemented separately.

RAM 1817 may be configured to interface via bus 1802 to processing circuitry 1801 to provide storage or caching of data or computer instructions during the execution of software programs such as the operating system, application programs, and device drivers. ROM 1819 may be configured to provide computer instructions or data to processing circuitry 1801. For example, ROM 1819 may be configured to store invariant low-level system code or data for basic system functions such as basic input and output (I/O), startup, or reception of keystrokes from a keyboard that are stored in a non-volatile memory. Storage medium 1821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1821 may be configured to include operating system 1823, application program 1825 such as a web browser application, a widget or gadget engine or another application, and data file 1827. Storage medium 1821 may store, for use by UE 1800, any of a variety of various operating systems or combinations of operating systems.

Storage medium 1821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1821 may allow UE 1800 to access computer-executable instructions, application programs or the like, stored on transitory or non-transitory memory media, to off-load data, or to upload data. An article of manufacture, such as one utilizing a communication system may be tangibly embodied in storage medium 1821, which may comprise a device readable medium.

In FIG. 18, processing circuitry 1801 may be configured to communicate with network 1843b using communication subsystem 1831. Network 1843a and network 1843b may be the same network or networks or different network or networks. Communication subsystem 1831 may be configured to include one or more transceivers used to communicate with network 1843b. For example, communication subsystem 1831 may be configured to include one or more transceivers used to communicate with one or more remote transceivers of another device capable of wireless communication such as another WD, UE, or base station of a radio access network (RAN) according to one or more communication protocols, such as IEEE 802.18, CDMA, WCDMA, GSM, LTE, UTRAN, WiMax, or the like. Each transceiver may include transmitter 1833 and/or receiver 1835 to implement transmitter or receiver functionality, respectively, appropriate to the RAN links (e.g., frequency allocations and the like). Further, transmitter 1833 and receiver 1835 of each transceiver may share circuit components, software or firmware, or alternatively may be implemented separately.

In the illustrated embodiment, the communication functions of communication subsystem 1831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1831 may include cellular communication, Wi-Fi communication, Bluetooth communication, and GPS communication. Network 1843b may encompass wired and/or wireless networks such as a local-area network (LAN), a wide-area network (WAN), a computer network, a wireless network, a telecommunications network, another like network or any combination thereof. For example, network 1843b may be a cellular network, a Wi-Fi network, and/or a near-field network. Power source 1813 may be configured to provide alternating current (AC) or direct current (DC) power to components of UE 1800.

The features, benefits and/or functions described herein may be implemented in one of the components of UE 1800 or partitioned across multiple components of UE 1800. Further, the features, benefits, and/or functions described herein may be implemented in any combination of hardware, software or firmware. In one example, communication subsystem 1831 may be configured to include any of the components described herein. Further, processing circuitry 1801 may be configured to communicate with any of such components over bus 1802. In another example, any of such components may be represented by program instructions stored in memory that when executed by processing circuitry 1801 perform the corresponding functions described herein. In another example, the functionality of any of such components may be partitioned between processing circuitry 1801 and communication subsystem 1831. In another example, the non-computationally intensive functions of any of such components may be implemented in software or firmware and the computationally intensive functions may be implemented in hardware.

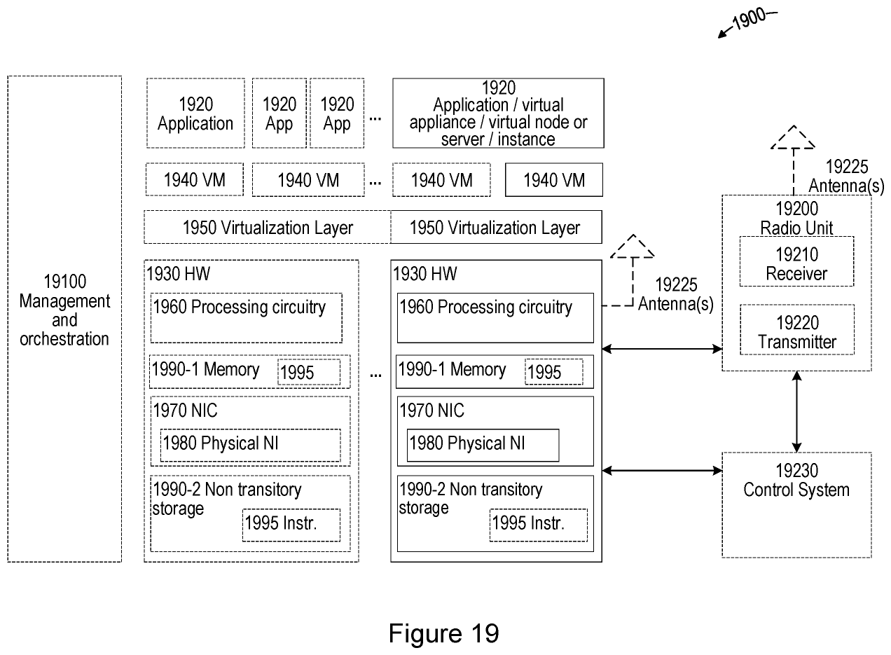

FIG. 19 is a schematic block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1900 hosted by one or more of hardware nodes 1930. Further, in embodiments in which the virtual node is not a radio access node or does not require radio connectivity (e.g., a core network node), then the network node may be entirely virtualized.

The functions may be implemented by one or more applications 1920 (which may alternatively be called software instances, virtual appliances, network functions, virtual nodes, virtual network functions, etc.) operative to implement some of the features, functions, and/or benefits of some of the embodiments disclosed herein. Applications 1920 are run in virtualization environment 1900 which provides hardware 1930 comprising processing circuitry 1960 and memory 1990. Memory 1990 contains instructions 1995 executable by processing circuitry 1960 whereby application 1920 is operative to provide one or more of the features, benefits, and/or functions disclosed herein.

Virtualization environment 1900, comprises general-purpose or special-purpose network hardware devices 1930 comprising a set of one or more processors or processing circuitry 1960, which may be commercial off-the-shelf (COTS) processors, dedicated Application Specific Integrated Circuits (ASICs), or any other type of processing circuitry including digital or analog hardware components or special purpose processors. Each hardware device may comprise memory 1990-1 which may be non-persistent memory for temporarily storing instructions 1995 or software executed by processing circuitry 1960. Each hardware device may comprise one or more network interface controllers (NICs) 1970, also known as network interface cards, which include physical network interface 1980. Each hardware device may also include non-transitory, persistent, machine-readable storage media 1990-2 having stored therein software 1995 and/or instructions executable by processing circuitry 1960. Software 1995 may include any type of software including software for instantiating one or more virtualization layers 1950 (also referred to as hypervisors), software to execute virtual machines 1940 as well as software allowing it to execute functions, features and/or benefits described in relation with some embodiments described herein.

Virtual machines 1940, comprise virtual processing, virtual memory, virtual networking or interface and virtual storage, and may be run by a corresponding virtualization layer 1950 or hypervisor. Different embodiments of the instance of virtual appliance 1920 may be implemented on one or more of virtual machines 1940, and the implementations may be made in different ways.

During operation, processing circuitry 1960 executes software 1995 to instantiate the hypervisor or virtualization layer 1950, which may sometimes be referred to as a virtual machine monitor (VMM). Virtualization layer 1950 may present a virtual operating platform that appears like networking hardware to virtual machine 1940.

As shown in FIG. 19, hardware 1930 may be a standalone network node with generic or specific components. Hardware 1930 may comprise antenna 19225 and may implement some functions via virtualization. Alternatively, hardware 1930 may be part of a larger cluster of hardware (e.g. such as in a data center or customer premise equipment (CPE)) where many hardware nodes work together and are managed via management and orchestration (MANO) 19100, which, among others, oversees lifecycle management of applications 1920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1940 may be a software implementation of a physical machine that runs programs as if they were executing on a physical, non-virtualized machine. Each of virtual machines 1940, and that part of hardware 1930 that executes that virtual machine, be it hardware dedicated to that virtual machine and/or hardware shared by that virtual machine with others of the virtual machines 1940, forms a separate virtual network elements (VNE).

Still in the context of NFV, Virtual Network Function (VNF) is responsible for handling specific network functions that run in one or more virtual machines 1940 on top of hardware networking infrastructure 1930 and corresponds to application 1920 in FIG. 19.

In some embodiments, one or more radio units 19200 that each include one or more transmitters 19220 and one or more receivers 19210 may be coupled to one or more antennas 19225. Radio units 19200 may communicate directly with hardware nodes 1930 via one or more appropriate network interfaces and may be used in combination with the virtual components to provide a virtual node with radio capabilities, such as a radio access node or a base station.

In some embodiments, some signalling can be effected with the use of control system 19230 which may alternatively be used for communication between the hardware nodes 1930 and radio units 19200.

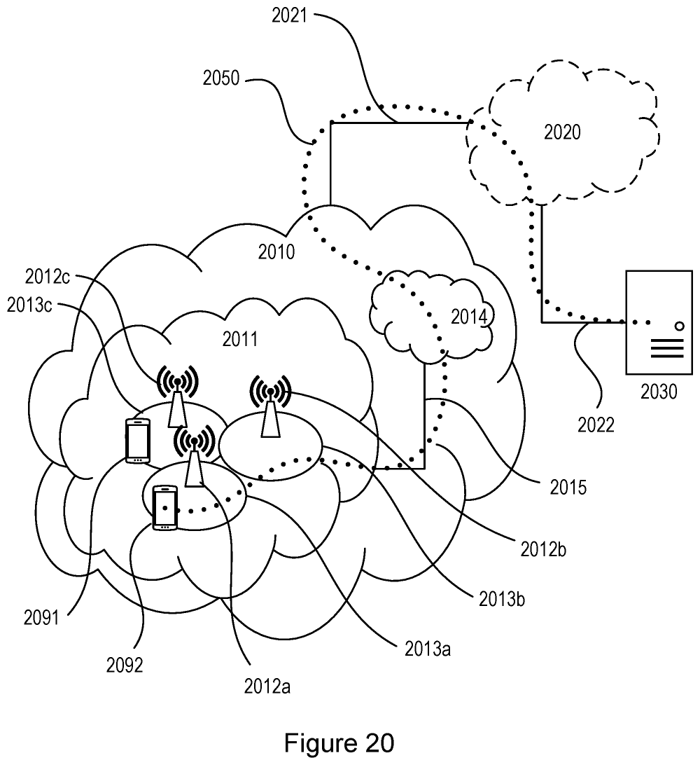

FIG. 20 illustrates a telecommunication network connected via an intermediate network to a host computer in accordance with some embodiments. In particular, with reference to FIG. 20, in accordance with an embodiment, a communication system includes telecommunication network 2010, such as a 3GPP-type cellular network, which comprises access network 2011, such as a radio access network, and core network 2014. Access network 2011 comprises a plurality of base stations 2012a, 2012b, 2012c, such as NBs, eNBs, gNBs or other types of wireless access points, each defining a corresponding coverage area 2013a, 2013b, 2013c. Each base station 2012a, 2012b, 2012c is connectable to core network 2014 over a wired or wireless connection 2015. A first UE 2091 located in coverage area 2013c is configured to wirelessly connect to, or be paged by, the corresponding base station 2012c. A second UE 2092 in coverage area 2013a is wirelessly connectable to the corresponding base station 2012a. While a plurality of UEs 2091, 2092 are illustrated in this example, the disclosed embodiments are equally applicable to a situation where a sole UE is in the coverage area or where a sole UE is connecting to the corresponding base station 2012.

Telecommunication network 2010 is itself connected to host computer 2030, which may be embodied in the hardware and/or software of a standalone server, a cloud-implemented server, a distributed server or as processing resources in a server farm. Host computer 2030 may be under the ownership or control of a service provider, or may be operated by the service provider or on behalf of the service provider. Connections 2021 and 2022 between telecommunication network 2010 and host computer 2030 may extend directly from core network 2014 to host computer 2030 or may go via an optional intermediate network 2020. Intermediate network 2020 may be one of, or a combination of more than one of, a public, private or hosted network; intermediate network 2020, if any, may be a backbone network or the Internet; in particular, intermediate network 2020 may comprise two or more sub-networks (not shown).

The communication system of FIG. 20 as a whole enables connectivity between the connected UEs 2091, 2092 and host computer 2030. The connectivity may be described as an over-the-top (OTT) connection 2050. Host computer 2030 and the connected UEs 2091, 2092 are configured to communicate data and/or signaling via OTT connection 2050, using access network 2011, core network 2014, any intermediate network 2020 and possible further infrastructure (not shown) as intermediaries. OTT connection 2050 may be transparent in the sense that the participating communication devices through which OTT connection 2050 passes are unaware of routing of uplink and downlink communications. For example, base station 2012 may not or need not be informed about the past routing of an incoming downlink communication with data originating from host computer 2030 to be forwarded (e.g., handed over) to a connected UE 2091. Similarly, base station 2012 need not be aware of the future routing of an outgoing uplink communication originating from the UE 2091 towards the host computer 2030.

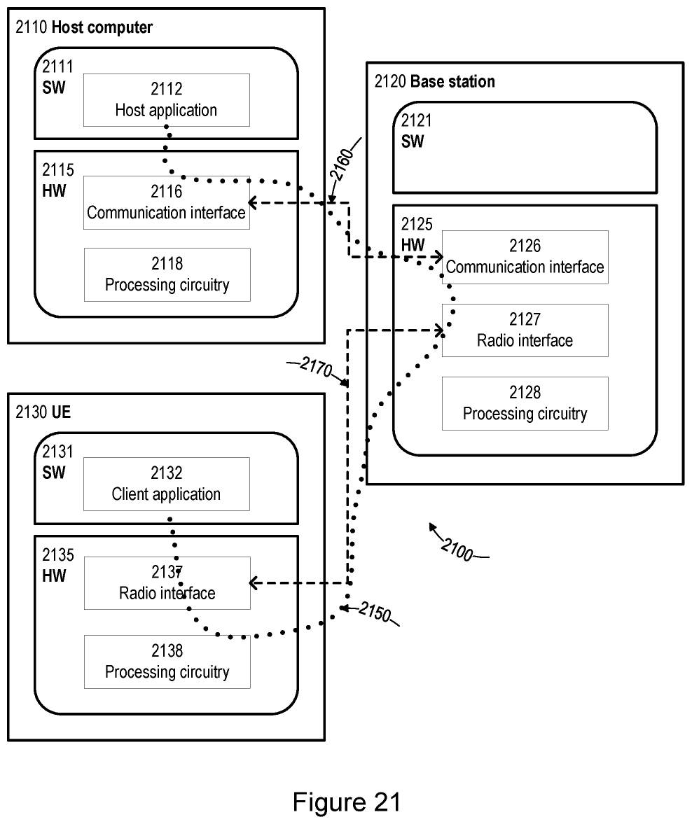

Example implementations, in accordance with an embodiment, of the wireless device (e.g. UE), network node (e.g. base station) and host computer discussed in the preceding paragraphs will now be described with reference to FIG. 21. FIG. 21 illustrates host computer communicating via a base station with a user equipment over a partially wireless connection in accordance with some embodiments In communication system 2100, host computer 2110 comprises hardware 2115 including communication interface 2116 configured to set up and maintain a wired or wireless connection with an interface of a different communication device of communication system 2100. Host computer 2110 further comprises processing circuitry 2118, which may have storage and/or processing capabilities. In particular, processing circuitry 2118 may comprise one or more programmable processors, application-specific integrated circuits, field programmable gate arrays or combinations of these (not shown) adapted to execute instructions. Host computer 2110 further comprises software 2111, which is stored in or accessible by host computer 2110 and executable by processing circuitry 2118. Software 2111 includes host application 2112. Host application 2112 may be operable to provide a service to a remote user, such as UE 2130 connecting via OTT connection 2150 terminating at UE 2130 and host computer 2110. In providing the service to the remote user, host application 2112 may provide user data which is transmitted using OTT connection 2150.

Communication system 2100 further includes base station 2120 provided in a telecommunication system and comprising hardware 2125 enabling it to communicate with host computer 2110 and with UE 2130. Hardware 2125 may include communication interface 2126 for setting up and maintaining a wired or wireless connection with an interface of a different communication device of communication system 2100, as well as radio interface 2127 for setting up and maintaining at least wireless connection 2170 with UE 2130 located in a coverage area (not shown in FIG. 21) served by base station 2120. Communication interface 2126 may be configured to facilitate connection 2160 to host computer 2110. Connection 2160 may be direct or it may pass through a core network (not shown in FIG. 21) of the telecommunication system and/or through one or more intermediate networks outside the telecommunication system. In the embodiment shown, hardware 2125 of base station 2120 further includes processing circuitry 2128, which may comprise one or more programmable processors, application-specific integrated circuits, field programmable gate arrays or combinations of these (not shown) adapted to execute instructions. Base station 2120 further has software 2121 stored internally or accessible via an external connection.

Communication system 2100 further includes UE 2130 already referred to. Its hardware 2135 may include radio interface 2137 configured to set up and maintain wireless connection 2170 with a base station serving a coverage area in which UE 2130 is currently located. Hardware 2135 of UE 2130 further includes processing circuitry 2138, which may comprise one or more programmable processors, application-specific integrated circuits, field programmable gate arrays or combinations of these (not shown) adapted to execute instructions. UE 2130 further comprises software 2131, which is stored in or accessible by UE 2130 and executable by processing circuitry 2138. Software 2131 includes client application 2132. Client application 2132 may be operable to provide a service to a human or non-human user via UE 2130, with the support of host computer 2110. In host computer 2110, an executing host application 2112 may communicate with the executing client application 2132 via OTT connection 2150 terminating at UE 2130 and host computer 2110. In providing the service to the user, client application 2132 may receive request data from host application 2112 and provide user data in response to the request data. OTT connection 2150 may transfer both the request data and the user data. Client application 2132 may interact with the user to generate the user data that it provides.

It is noted that host computer 2110, base station 2120 and UE 2130 illustrated in FIG. 21 may be similar or identical to host computer 2030, one of base stations 2012a, 2012b, 2012c and one of UEs 2091, 2092 of FIG. 20, respectively. This is to say, the inner workings of these entities may be as shown in FIG. 21 and independently, the surrounding network topology may be that of FIG. 20.

In FIG. 21, OTT connection 2150 has been drawn abstractly to illustrate the communication between host computer 2110 and UE 2130 via base station 2120, without explicit reference to any intermediary devices and the precise routing of messages via these devices. Network infrastructure may determine the routing, which it may be configured to hide from UE 2130 or from the service provider operating host computer 2110, or both. While OTT connection 2150 is active, the network infrastructure may further take decisions by which it dynamically changes the routing (e.g., on the basis of load balancing consideration or reconfiguration of the network).

Wireless connection 2170 between UE 2130 and base station 2120 is in accordance with the teachings of the embodiments described throughout this disclosure. One or more of the various embodiments improve the performance of OTT services provided to UE 2130 using OTT connection 2150, in which wireless connection 2170 forms the last segment.

A measurement procedure may be provided for the purpose of monitoring data rate, latency and other factors on which the one or more embodiments improve. There may further be an optional network functionality for reconfiguring OTT connection 2150 between host computer 2110 and UE 2130, in response to variations in the measurement results. The measurement procedure and/or the network functionality for reconfiguring OTT connection 2150 may be implemented in software 2111 and hardware 2115 of host computer 2110 or in software 2131 and hardware 2135 of UE 2130, or both. In embodiments, sensors (not shown) may be deployed in or in association with communication devices through which OTT connection 2150 passes; the sensors may participate in the measurement procedure by supplying values of the monitored quantities exemplified above, or supplying values of other physical quantities from which software 2111, 2131 may compute or estimate the monitored quantities. The reconfiguring of OTT connection 2150 may include message format, retransmission settings, preferred routing etc.; the reconfiguring need not affect base station 2120, and it may be unknown or imperceptible to base station 2120. Such procedures and functionalities may be known and practiced in the art. In certain embodiments, measurements may involve proprietary UE signaling facilitating host computer 2110's measurements of throughput, propagation times, latency and the like. The measurements may be implemented in that software 2111 and 2131 causes messages to be transmitted, in particular empty or ‘dummy’ messages, using OTT connection 2150 while it monitors propagation times, errors etc.

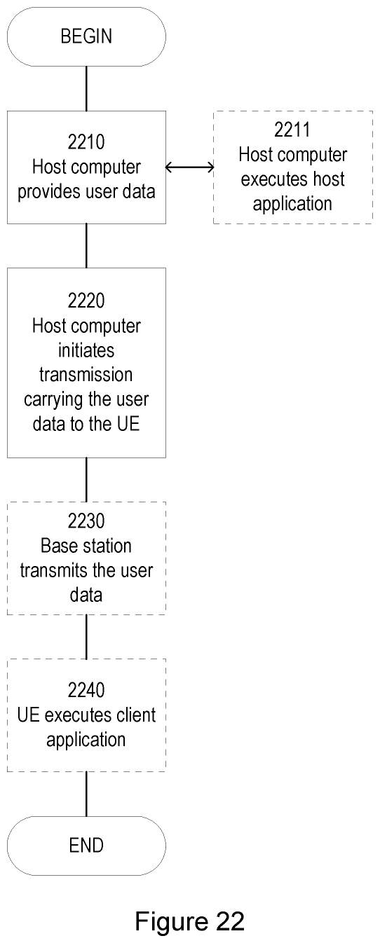

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In step 2210, the host computer provides user data. In substep 2211 (which may be optional) of step 2210, the host computer provides the user data by executing a host application. In step 2220, the host computer initiates a transmission carrying the user data to the UE. In step 2230 (which may be optional), the base station transmits to the UE the user data which was carried in the transmission that the host computer initiated, in accordance with the teachings of the embodiments described throughout this disclosure. In step 2240 (which may also be optional), the UE executes a client application associated with the host application executed by the host computer.

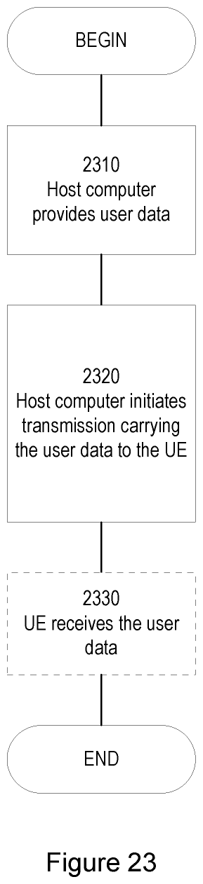

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In step 2310 of the method, the host computer provides user data. In an optional substep (not shown) the host computer provides the user data by executing a host application. In step 2320, the host computer initiates a transmission carrying the user data to the UE. The transmission may pass via the base station, in accordance with the teachings of the embodiments described throughout this disclosure. In step 2330 (which may be optional), the UE receives the user data carried in the transmission.

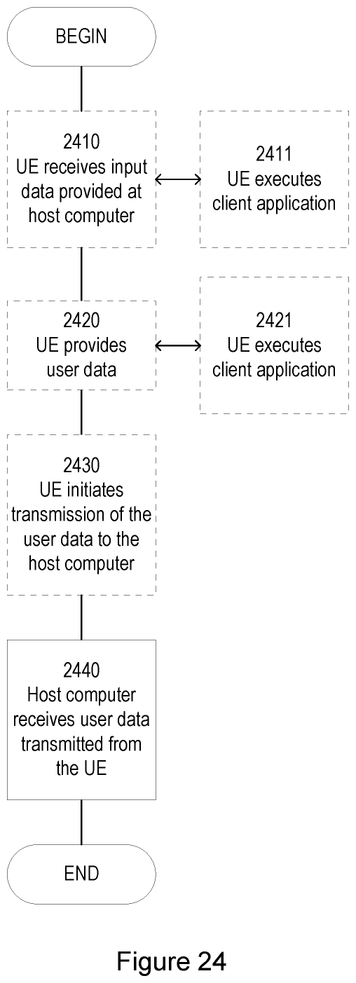

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In step 2410 (which may be optional), the UE receives input data provided by the host computer. Additionally or alternatively, in step 2420, the UE provides user data. In substep 2421 (which may be optional) of step 2420, the UE provides the user data by executing a client application. In substep 2411 (which may be optional) of step 2410, the UE executes a client application which provides the user data in reaction to the received input data provided by the host computer. In providing the user data, the executed client application may further consider user input received from the user. Regardless of the specific manner in which the user data was provided, the UE initiates, in substep 2430 (which may be optional), transmission of the user data to the host computer. In step 2440 of the method, the host computer receives the user data transmitted from the UE, in accordance with the teachings of the embodiments described throughout this disclosure.

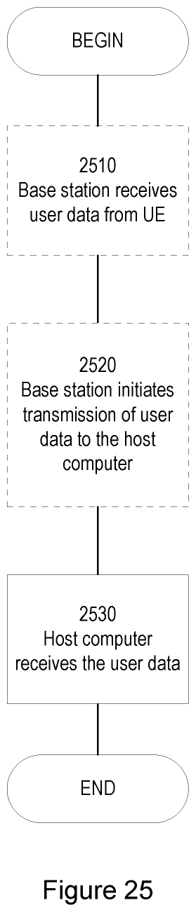

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In step 2510 (which may be optional), in accordance with the teachings of the embodiments described throughout this disclosure, the base station receives user data from the UE. In step 2520 (which may be optional), the base station initiates transmission of the received user data to the host computer. In step 2530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. Additional information may also be found in the document(s) provided in the Appendix.

### EMBODIMENTS

### Group A Embodiments

A1. A method performed by a wireless device that comprises radio equipment and terminal equipment, the method comprising:
receiving connection reconfiguration signaling from a wireless communication network at the radio equipment of the wireless device, wherein the connection reconfiguration signaling indicates reconfiguration of a connection that the radio equipment has with the wireless communication network; and
transmitting, from the radio equipment to the terminal equipment of the wireless device, notification signaling (26) that notifies the terminal equipment of the reconfiguration of the connection.

A2. The method of embodiment A1, further comprising, responsive to receiving the connection reconfiguration signaling, determining whether to transmit the notification signaling to the terminal equipment of the wireless device.

A3. The method of embodiment A2, wherein said determining comprises determining whether the indicated reconfiguration of the connection is a type of reconfiguration of which the radio equipment is to notify the terminal equipment.

A4. The method of any of embodiments A1-A3, further comprising filtering the received connection reconfiguration signaling to extract one or more parameters characterizing the reconfiguration of the connection, and whether the notification signaling includes or is based on the one or more parameters extracted.

A5. A method performed by a wireless device that comprises radio equipment and terminal equipment, the method comprising:
receiving, at the terminal equipment of the wireless device, notification signaling (26, 34) indicating reconfiguration of a connection that the radio equipment of the wireless device has with a wireless communication network.

A6. The method of embodiment A5, wherein the notification signaling (26) is received from the radio equipment of the wireless device.

A7. The method of embodiment A5, wherein the connection supports data transfer between the wireless device and endpoint communication equipment, and wherein the notification signaling (34) is received from the endpoint communication equipment.

A8. The method of embodiment A7, wherein the endpoint communication equipment is an application server.

A9. A method performed by a wireless device that comprises radio equipment and terminal equipment, the method comprising:
transmitting, from the terminal equipment of the wireless device to endpoint communication equipment, notification signaling (28) indicating one or more of:
   reconfiguration of a connection that the radio equipment of the wireless device has with a wireless communication network; and
   adaptation of one or more parameters at the terminal equipment in accordance with the reconfiguration of the connection;
wherein the connection supports data transfer between the wireless device and the endpoint communication equipment.

A10. The method of any of embodiments A5-A9, further comprising, based on the reconfiguration of the connection, adapting one or more parameters at the terminal equipment.

A11. The method of any of embodiments A9-A10, wherein the one or more parameters govern generation and/or transfer of data between the wireless device and endpoint communication equipment.

A12. The method of any of embodiments A9-A11, wherein the one or more parameters govern a rate, amount, and/or latency of data transfer between the wireless device and endpoint communication equipment.

A13. The method of any of embodiments A10-A12, wherein said adapting comprises adapting the one or more parameters according to the reconfiguration of the connection.

A14. The method of any of embodiments A10-A13, wherein said adapting comprises adapting the one or more parameters to enable or disable a specific application executable by the terminal equipment.

A15. The method of any of embodiments A10-A14, wherein said adapting comprises adapting the one or more parameters to adjust priorities among multiple traffic flows between the wireless device and the endpoint communication equipment.

A16. The method of any of embodiments A10-A15, wherein the reconfiguration of the connection comprises setup or release of a coverage enhancement mode for the connection, and wherein said adapting comprises adapting a rate, amount, and/or latency of data transfer between the wireless device and endpoint communication equipment to be supportable by the connection as reconfigured.

A17. The method of any of the Group A Embodiments, wherein the notification signaling indicates how the connection is reconfigured.

A18. The method of any of the Group A Embodiments, wherein the reconfiguration of the connection comprises setup or release of a coverage enhancement mode for the connection.

A19. The method of any of the Group A Embodiments, wherein the wireless device is capable of transmitting or receiving over a frequency bandwidth greater than 1.08 MHz.

A20. The method of any of the Group A Embodiments, wherein the wireless device is capable of vehicle-to-everything communication.

A21. The method of any of the Group A Embodiments, wherein endpoint communication equipment comprises an application server.

A22. The method of any of the Group A Embodiments, wherein the connection is a radio resource control connection.

### Group B Embodiments

B1. A method performed by a radio network node configured for use in a wireless communication network, the method comprising:
transmitting connection reconfiguration signaling from the radio network node to a wireless device, wherein the connection reconfiguration signaling indicates reconfiguration of a connection that radio equipment of the wireless device has with the radio network node; and
transmitting, from the radio network node to a core network node in the wireless communication network, notification signaling (30) that notifies the core network node of the reconfiguration of the connection.

B2. The method of embodiment B1, further comprising determining whether to transmit the notification signaling.

B3. The method of embodiment B2, wherein said determining comprises determining whether the indicated reconfiguration of the connection is a type of reconfiguration of which the radio network node is to notify the core network node.

B4. The method of any of embodiments B1-B3, further comprising filtering the received connection reconfiguration signaling to extract one or more parameters characterizing the reconfiguration of the connection, and whether the notification signaling includes or is based on the one or more parameters extracted.

B5. The method of any of the Group B Embodiments, wherein the notification signaling indicates how the connection is reconfigured.

B6. The method of any of the Group B Embodiments, wherein the reconfiguration of the connection comprises setup or release of a coverage enhancement mode for the connection.

B7. The method of any of the Group B Embodiments, wherein the wireless device is capable of transmitting or receiving over a frequency bandwidth greater than 1.08 MHz.

B8. The method of any of the Group B Embodiments, wherein the wireless device is capable of vehicle-to-everything communication.

B9. The method of any of the Group B Embodiments, wherein the connection is a radio resource control connection.

### Group C Embodiments

C1. A method performed by a core network node configured for use in a wireless communication network, the method comprising:
receiving, from a radio network node in the wireless communication network, notification signaling (30) indicating reconfiguration of a connection that radio equipment of a wireless device has with the radio network node.

C2. A method performed by a core network node configured for use in a wireless communication network, the method comprising:
transmitting, from the core network towards endpoint communication equipment, notification signaling (32) indicating one or more of:
   reconfiguration of a connection that radio equipment of the wireless device has with a radio network node; and
   adaptation of one or more parameters at the core network node in accordance with the reconfiguration of the connection;
wherein the connection supports data transfer between the wireless device and the endpoint communication equipment.

C3. The method of embodiment C2, wherein transmitting the notification signaling towards the endpoint communication equipment comprises transmitting the notification signaling to an application function associated with the endpoint communication equipment.

C4. The method of any of embodiments C1-03, further comprising, based on the reconfiguration of the connection, adapting one or more parameters at the core network node.

C5. The method of any of embodiments C2-C4, wherein the one or more parameters govern generation and/or transfer of data between the wireless device and endpoint communication equipment.

C6. The method of any of embodiments C2-05, wherein the one or more parameters govern a rate, amount, and/or latency of data transfer between the wireless device and endpoint communication equipment.

C7. The method of any of embodiments C4-C6 wherein said adapting comprises adapting the one or more parameters according to the reconfiguration of the connection.

C8. The method of any of embodiments C4-C7, wherein said adapting comprises adapting the one or more parameters to enable or disable a specific application executable by the terminal equipment and/or the core network node.

C9. The method of any of embodiments C4-C8, wherein said adapting comprises adapting the one or more parameters to adjust priorities among multiple traffic flows between the wireless device and the endpoint communication equipment.

C10. The method of any of embodiments C4-C9, wherein the reconfiguration of the connection comprises setup or release of a coverage enhancement mode for the connection, and wherein said adapting comprises adapting a rate, amount, and/or latency of data transfer between the wireless device and endpoint communication equipment to be supportable by the connection as reconfigured.

C11. The method of any of embodiments C2-C10, wherein the one or more parameters include one or more parameters of a network policy for treating data transferred between the wireless device and endpoint communication equipment.

C12. The method of any of the Group C Embodiments, wherein the notification signaling indicates how the connection is reconfigured.

C13. The method of any of the Group C Embodiments, wherein the reconfiguration of the connection comprises setup or release of a coverage enhancement mode for the connection.

C14. The method of any of the Group C Embodiments, wherein the wireless device is capable of transmitting or receiving over a frequency bandwidth greater than 1.08 MHz.

C15. The method of any of the Group C Embodiments, wherein the wireless device is capable of vehicle-to-everything communication.

C16. The method of any of the Group C Embodiments, wherein endpoint communication equipment comprises an application server.

C17. The method of any of the Group C Embodiments, wherein the connection is a radio resource control connection.

### Group D Embodiments

D1. A method performed by endpoint communication equipment, the method comprising:
transmitting or receiving notification signaling (28, 34) indicating one or more of:
   reconfiguration of a connection that radio equipment of a wireless device has with a radio network node; and
   adaptation of one or more parameters in accordance with the reconfiguration of the connection;
wherein the connection supports data transfer between the wireless device and the endpoint communication equipment.

D2. The method of embodiment D1, wherein said transmitting or receiving comprises receiving the notification signaling (28).

D3. The method of any of embodiments D1-D2, wherein the notification signaling (32) is received from a core network node in the wireless communication network.

D4. The method of any of embodiments D1-D3, wherein the notification signaling (28) is received from the wireless device.

D5. The method of embodiment D1, wherein said transmitting or receiving comprises transmitting the notification signaling (34) to the wireless device.

D6. The method of any of embodiments D1-D5, further comprising, based on the reconfiguration of the connection, adapting one or more parameters at the endpoint communication equipment.

D7. The method of any of embodiments D1-D6, wherein the one or more parameters govern generation and/or transfer of data between the wireless device and endpoint communication equipment.

D8. The method of any of embodiments D1-D7, wherein the one or more parameters govern a rate, amount, and/or latency of data transfer between the wireless device and endpoint communication equipment.

D9. The method of any of embodiments D1-D8, wherein said adapting comprises adapting the one or more parameters according to the reconfiguration of the connection.

D10. The method of any of embodiments D6-D8, wherein said adapting comprises adapting the one or more parameters to enable or disable a specific application executable by the terminal equipment and/or the core network node.

D11. The method of any of embodiments D6-D9, wherein said adapting comprises adapting the one or more parameters to adjust priorities among multiple traffic flows between the wireless device and the endpoint communication equipment.

D12. The method of any of embodiments D6-D10, wherein the reconfiguration of the connection comprises setup or release of a coverage enhancement mode for the connection, and wherein said adapting comprises adapting a rate, amount, and/or latency of data transfer between the wireless device and endpoint communication equipment to be supportable by the connection as reconfigured.

D13. The method of any of embodiments D1-D12, wherein the one or more parameters include one or more parameters of a network policy for treating traffic of the connection.

D14. The method of any of the Group D Embodiments, wherein the notification signaling indicates how the connection is reconfigured.

D15. The method of any of the Group D Embodiments, wherein the reconfiguration of the connection comprises setup or release of a coverage enhancement mode for the connection.

D16. The method of any of the Group D Embodiments, wherein the wireless device is capable of transmitting or receiving over a frequency bandwidth greater than 1.08 MHz.

D17. The method of any of the Group D Embodiments, wherein the wireless device is capable of vehicle-to-everything communication.

D18. The method of any of the Group D Embodiments, wherein the endpoint communication equipment comprises an application server.

D19. The method of any of the Group D Embodiments, wherein the connection is a radio resource control connection.

### Group E Embodiments

E1. A method performed by a network node configured for use in a wireless communication network, the method comprising:
determining, based on one or more decision criteria, whether to trigger reconfiguration of a connection between a wireless device and the wireless communication network and/or how to reconfigure the connection, wherein the one or more decision criteria include one or more of:
   location information for the wireless device;
   channel information for the wireless device;
   communication traffic information for the wireless device;
   subscription information for the wireless device;
   one or more limitations on reconfiguration of the connection;
   one or more capabilities of the wireless device; or
   loading information for the wireless communication network.

E2. The method of embodiment E1, wherein the location information, the channel information, and/or the loading information is predicted information.

E3. The method of any of embodiments E1-E2, wherein the channel information is based on a coverage map and/or an estimated or predicted trajectory of the wireless device.

E4. The method of any of embodiments E1-E3, wherein the communication traffic information comprises one or more of:
one or more quality of service requirements for current or predicted traffic transmitted to or received from the wireless device;
amount of current or predicted traffic transmitted to or received from the wireless device; or
a type of current or predicted traffic transmitted to or received from the wireless device.

E5. The method of any of embodiments E1-E4, wherein the subscription information includes one or more of:
information indicating which one or more types of reconfigurations of the connection the wireless device is allowed to perform; or
a priority of the wireless device for admission control for different types of coverage modes.

E6. The method of any of embodiments E1-E5, wherein the one or more limitations include one or more of:
one or more geographical areas in which reconfiguration of the connection is allowed or forbidden;
one or more time intervals during which reconfiguration of the connection is allowed or forbidden;
a duration threshold, wherein the connection is to be reconfigured when one or more conditions are met for at least the duration threshold.

E7. The method of any of embodiments E1-E5, wherein the one or more capabilities include which types of reconfigurations of the connection the wireless device supports.

E8. The method of any of embodiments E1-E7, wherein the loading information includes a number of wireless devices that are using or expected to use a certain coverage enhancement mode.

E9. The method of any of embodiments E1-E8, further comprising transmitting control signaling indicating reconfiguration of the connection according to said determining.

E10. The method of any of embodiments E1-E9, wherein said determining comprises determining, based on the one or more decision criteria, whether to reconfigure the connection by setting up or releasing a coverage enhancement mode for the connection.

E11. The method of any of embodiments E1-E10, wherein the connection is a radio resource control connection.

### Group F Embodiments

F1. A wireless device configured to perform any of the steps of any of the Group A embodiments.

F2. A wireless device comprising processing circuitry configured to perform any of the steps of any of the Group A embodiments.

F3. A wireless device comprising:
communication circuitry; and
processing circuitry configured to perform any of the steps of any of the Group A embodiments.

F4. A wireless device comprising:
processing circuitry configured to perform any of the steps of any of the Group A embodiments; and
power supply circuitry configured to supply power to the wireless device.

F5. A wireless device comprising:
processing circuitry and memory, the memory containing instructions executable by the processing circuitry whereby the wireless device is configured to perform any of the steps of any of the Group A embodiments.

F6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

F7. A computer program comprising instructions which, when executed by at least one processor of a wireless device, causes the wireless device to carry out the steps of any of the Group A embodiments.

F8. A carrier containing the computer program of embodiment C7, wherein the carrier is one of an electronic signal, optical signal, radio signal, or computer readable storage medium.

F9. A radio network node configured to perform any of the steps of any of the Group B embodiments.

F10. A radio network node comprising processing circuitry configured to perform any of the steps of any of the Group B embodiments.

F11. A radio network node comprising:
communication circuitry; and
processing circuitry configured to perform any of the steps of any of the Group B embodiments.

F12. A radio network node comprising:
processing circuitry configured to perform any of the steps of any of the Group B embodiments;
power supply circuitry configured to supply power to the radio network node.

F13. A radio network node comprising:
processing circuitry and memory, the memory containing instructions executable by the processing circuitry whereby the radio network node is configured to perform any of the steps of any of the Group B embodiments.

F14. The radio network node of any of embodiments C9-C13, wherein the radio network node is a base station.

F15. A computer program comprising instructions which, when executed by at least one processor of a radio network node, causes the radio network node to carry out the steps of any of the Group B embodiments.

F16. The computer program of embodiment C14, wherein the radio network node is a base station.

F17. A carrier containing the computer program of any of embodiments C15-C16, wherein the carrier is one of an electronic signal, optical signal, radio signal, or computer readable storage medium.

F18. A core network node configured to perform any of the steps of any of the Group C embodiments.

F19. A core network node comprising processing circuitry configured to perform any of the steps of any of the Group C embodiments.

F20. A core network node comprising:
communication circuitry; and
processing circuitry configured to perform any of the steps of any of the Group C embodiments.

F21. A core network node comprising:
processing circuitry configured to perform any of the steps of any of the Group C embodiments;
power supply circuitry configured to supply power to the core network node.

F22. A core network node comprising:
processing circuitry and memory, the memory containing instructions executable by the processing circuitry whereby the core network node is configured to perform any of the steps of any of the Group C embodiments.

F23. A computer program comprising instructions which, when executed by at least one processor of a core network node, causes the core network node to carry out the steps of any of the Group C embodiments.

F24. A carrier containing the computer program of embodiment F23, wherein the carrier is one of an electronic signal, optical signal, radio signal, or computer readable storage medium.

F25. Endpoint communication equipment configured to perform any of the steps of any of the Group D embodiments.

F26. Endpoint communication equipment comprising processing circuitry configured to perform any of the steps of any of the Group D embodiments.

F27. Endpoint communication equipment comprising:
communication circuitry; and
processing circuitry configured to perform any of the steps of any of the Group D embodiments.

F28. Endpoint communication equipment comprising:
processing circuitry configured to perform any of the steps of any of the Group D embodiments;
power supply circuitry configured to supply power to the endpoint communication equipment.

F29. Endpoint communication equipment comprising:
processing circuitry and memory, the memory containing instructions executable by the processing circuitry whereby the endpoint communication equipment is configured to perform any of the steps of any of the Group D embodiments.

F30. A computer program comprising instructions which, when executed by at least one processor of endpoint communication equipment, causes the endpoint communication equipment to carry out the steps of any of the Group D embodiments.

F31. A carrier containing the computer program of embodiment F30, wherein the carrier is one of an electronic signal, optical signal, radio signal, or computer readable storage medium.

F32. A core network node configured to perform any of the steps of any of the Group E embodiments.

F33. A core network node comprising processing circuitry configured to perform any of the steps of any of the Group E embodiments.

F34. A core network node comprising:
communication circuitry; and
processing circuitry configured to perform any of the steps of any of the Group E embodiments.

F35. A core network node comprising:
processing circuitry configured to perform any of the steps of any of the Group E embodiments;
power supply circuitry configured to supply power to the core network node.

F36. A core network node comprising:
processing circuitry and memory, the memory containing instructions executable by the processing circuitry whereby the core network node is configured to perform any of the steps of any of the Group E embodiments.

F37. A computer program comprising instructions which, when executed by at least one processor of a core network node, causes the core network node to carry out the steps of any of the Group E embodiments.

F38. A carrier containing the computer program of embodiment F37, wherein the carrier is one of an electronic signal, optical signal, radio signal, or computer readable storage medium.

### Group G Embodiments

G1. A communication system including a host computer comprising:
processing circuitry configured to provide user data; and
a communication interface configured to forward the user data to a cellular network for transmission to a user equipment (UE), wherein the cellular network comprises a base station having a radio interface and processing circuitry, the base station's processing circuitry configured to perform any of the steps of any of the Group B embodiments.

G2. The communication system of the previous embodiment further including the base station.

G3. The communication system of the previous 2 embodiments, further including the UE, wherein the UE is configured to communicate with the base station.

G4. The communication system of the previous 3 embodiments, wherein:
the processing circuitry of the host computer is configured to execute a host application, thereby providing the user data; and
the UE comprises processing circuitry configured to execute a client application associated with the host application.

G5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

G6. The method of the previous embodiment, further comprising, at the base station, transmitting the user data.

G7. The method of the previous 2 embodiments, wherein the user data is provided at the host computer by executing a host application, the method further comprising, at the UE, executing a client application associated with the host application.

G8. A user equipment (UE) configured to communicate with a base station, the UE comprising a radio interface and processing circuitry configured to perform any of the previous 3 embodiments.

G9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

G10. The communication system of the previous embodiment, wherein the cellular network further includes a base station configured to communicate with the UE.

G11. The communication system of the previous 2 embodiments, wherein:
the processing circuitry of the host computer is configured to execute a host application, thereby providing the user data; and
the UE's processing circuitry is configured to execute a client application associated with the host application.

G12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

G13. The method of the previous embodiment, further comprising at the UE, receiving the user data from the base station.

G14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

G15. The communication system of the previous embodiment, further including the U E.

G16. The communication system of the previous 2 embodiments, further including the base station, wherein the base station comprises a radio interface configured to communicate with the UE and a communication interface configured to forward to the host computer the user data carried by a transmission from the UE to the base station.

G17. The communication system of the previous 3 embodiments, wherein:
the processing circuitry of the host computer is configured to execute a host application; and
the UE's processing circuitry is configured to execute a client application associated with the host application, thereby providing the user data.

G18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

G19. A method implemented in a communication system including a host computer, a base station and a user equipment (UE), the method comprising:
at the host computer, receiving user data transmitted to the base station from the UE, wherein the UE performs any of the steps of any of the Group A embodiments.

G20. The method of the previous embodiment, further comprising, at the UE, providing the user data to the base station.

G21. The method of the previous 2 embodiments, further comprising:
at the UE, executing a client application, thereby providing the user data to be transmitted; and
at the host computer, executing a host application associated with the client application.

G22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

G23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

G24. The communication system of the previous embodiment further including the base station.

G25. The communication system of the previous 2 embodiments, further including the UE, wherein the UE is configured to communicate with the base station.

G26. The communication system of the previous 3 embodiments, wherein:
the processing circuitry of the host computer is configured to execute a host application;
the UE is configured to execute a client application associated with the host application, thereby providing the user data to be received by the host computer.

G27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

G28. The method of the previous embodiment, further comprising at the base station, receiving the user data from the UE.

G29. The method of the previous 2 embodiments, further comprising at the base station, initiating a transmission of the received user data to the host computer.

### APPENDIX

Title: Reaction to QoS Prediction of Coverage Change

### 1 INTRODUCTION

5GAA eNESQO WI [1] aims at investigating application reaction to QoS Prediction in order to identify in details how OEMs and in general V2X services can take advantage of QoS Prediction. Moreover, the eNESQO WI also aims at understanding the possible reactions that the network itself might take according to QoS Prediction. Outputs of this analysis are expected to be collected in Section 5.6 Application and Network Reaction to QoS Prediction of the eNESQO TR [2].

The contribution 5GAA_A-190038 [3] presented during the WG2 F2F #9 meeting highlighted one aspect of relevance for V2X services, i.e., the fact that vehicles may benefit from the exploitation of MTC-specific features in addition to the exploitation of eMBB/URLLC features. For instance, the support of features such as coverage enhancement (CE) capabilities supported by e.g. LTE-M, would allow, for instance, to support basic connectivity towards vehicles driving into or parked in an underground garage by the use of transmission repetitions. In this scenario, the vehicle will operate as a legacy UE (operating in normal coverage mode) while moving and then services such as audio streaming or navigation will be available. In the parked state, the vehicle will operate as an MTC UE (using CE mode to exploit repetitions for enhanced coverage), thus switching to periodic transmissions of small amounts of data to a backend server, for example for tracking of current battery status. This example highlights the need of a capability supporting the adaptation of configuration at the vehicle-mounted UE, where CE mode is enabled according to vehicle's needs and coverage limitations.

The example discussed above can be considered as a possible reaction to the reception of QoS Prediction of coverage change, where in particular in this case the prediction is intended as prediction that the vehicle will be out of normal coverage and that the vehicle is reached by coverage enhancement operations. The availability of QoS Prediction of coverage change allows the application as well as the network to take proper reactions to adapt their behaviour considering the predicted upcoming loss of normal coverage and to the predicted availability of coverage in CE mode.

The aspects discussed above will be further investigated in this appendix, with focus on providing more details on three aspects for both application and network sides:
Behaviour configurations, which can be associated to different status or modes of operation;
Triggering conditions, which are monitored to understand whether an adaptation or change of behaviour configuration is needed, where the triggering conditions are influenced by the reception of QoS Prediction messages;
Reactions implemented when triggering conditions are met and used to adapt or change the behaviour configuration.

### 2 REACTION TO QOS PREDICTION OF COVERAGE CHANGE

In this section we consider two possible status of relevance associated to coverage: (i) normal coverage; (ii) coverage enhancement. In this Section, we discuss application and network reactions at the reception of QoS Prediction of coverage change. In this Section, we consider an example of prediction of coverage change containing the following information:
the UE will soon leave the status of normal coverage (i.e., the UE is currently served e.g. by a legacy LTE cell) with potential information about the time interval when the UE is predicted to leave the normal coverage together with information on for how long the UE is expected to do not be reached via normal coverage;
the UE is predicted to be reached by using CE mode operations (e.g., the UE is predicted to be reachable via LTE-M by enabling CE mode A or CE mode B) after leaving the normal coverage, potentially with information about for how long the UE is expected to have coverage in CE mode.

In order to understand how application and network might react to the reception of a prediction of coverage change, it is important to discuss how application and network sides behave differently according to the coverage status. For instance, different behaviour configurations might correspond to these statuses both at application and network sides. Examples of such configurations are:
Behaviour configuration at application side (both at vehicle and server side).
   Normal coverage. All applications/services are enabled, including applications ranging from small data transfer of delay-tolerant information to applications requiring for instance high bitrates, low latency, large amount of data transfer, etc. Example of such applications are: basic sensor reporting from the vehicle, massive sensor reporting from the vehicle, video streaming from the vehicle, remote control, basic connectivity for status check from remote server, software updates from remote servers, HD map acquisition from remote servers, infotainment service from remote servers, etc.
   Coverage enhancement. Only a reduced set of applications/services are enabled, for example applications associated to small data transfer of delay-tolerant information while applications with higher QoS requirements are disabled. Examples of applications allowed in this configuration are: basic sensor reporting from the vehicle and basic connectivity for status check from remote server.
Behaviour configuration at network side.
   Normal coverage. In this case, the UE operates in a normal mode and the network does not enforce any particular behaviour for the UE (in addition to usual configuration for admission control, QoS management, priority, etc.).
   Coverage enhancement. The network enforces CE-specific features which are in line with the UE operating in CE mode in order to, e.g., to limit the amount of transmitted data, reduce the maximum allowed bitrate of transmission, and so on. Examples might include specific policies for rate limitation, different charging, change of UE/traffic priority, and in general other changes of UE-related information for traffic treatment to comply with operations in CE mode.

The utilization of one of behaviour configurations presented above is driven by some triggering conditions. For instance, examples of triggering conditions are:
Application
   Behaviour change from normal coverage to coverage enhancement. The vehicle is parked (or expected to be parked within a short time) in a location where normal coverage is not available (or predicted to be not available) and the vehicle requires basic sensor reporting services or basic connectivity for status check from remote server.
   Behaviour change from coverage enhancement to normal coverage. The vehicle is moving (or predicted to be moving), the vehicle can be (or predicted to be) reached via normal coverage in the area where the vehicle is (or will be) moving, the vehicle requires other applications in addition to basic sensor reporting services or basic connectivity for status check from remote server.
Network
   Behaviour change from normal coverage to coverage enhancement. It is predicted that the UE will not be reachable by means of normal coverage and that the unreachability is expected to last longer that a certain time interval, but the UE is predicted to be reachable by using CE mode. The network is expected to have enough resources to serve the UE using CE mode.
   Behaviour change from coverage enhancement to normal coverage. The UE is moving in a location where normal coverage is available (or predicted to be available).

NOTE: it is assumed that the network is able to perform UE-specific authorization for the utilization of CE mode. It is FFS the details of such authorization mechanism.

In addition to behaviour configurations at application and network side and triggering conditions for behaviour configuration adaptation, it is important to analyse the reactions generated at application and network sides at the reception of a QoS Prediction message. In the following, it is considered the case when it is predicted a coverage change from normal coverage to coverage enhancement, although the analysis can be extended also for predictions of changes from coverage enhancement to normal coverage by properly adapting behaviour configurations, triggering conditions, and reactions.

2.1 Application Reaction to Prediction of Coverage Change

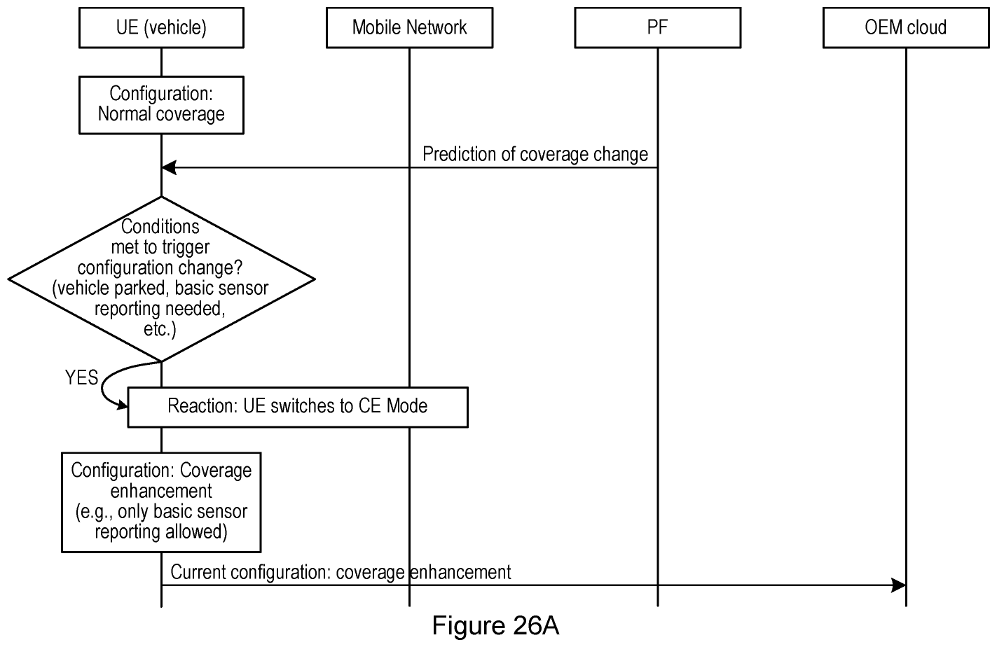

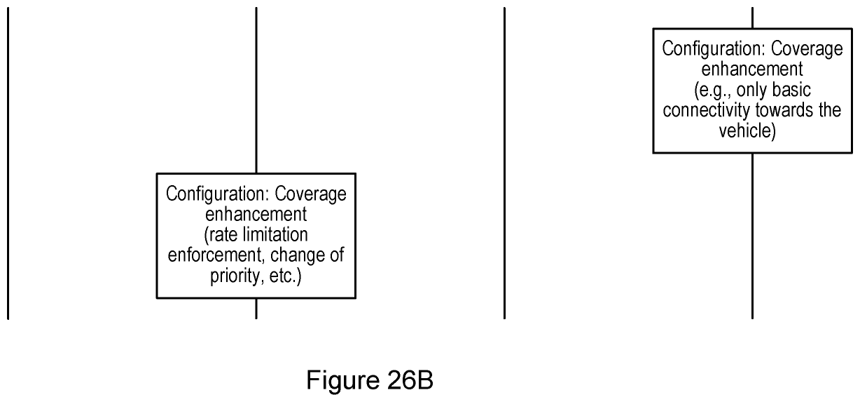

The flow diagram of application reaction to the reception of QoS Prediction of coverage change is depicted in FIG. 26A-B. In this example, it is assumed that the receivers of the QoS Prediction message from the Prediction Function (PF) is the vehicle application, i.e., at the UE side. The application reaction can be described as follows:
The vehicle is in the initial behaviour configuration associated to normal coverage. In this configuration, the UE modem is configured to work in normal coverage, i.e., the chipset didn't signal capabilities of supporting CE mode operation.
The vehicle receives the QoS Prediction of coverage change from the PF, indicating that the vehicle is expected to lose normal coverage within a certain time interval and that coverage enhancements operations can be used to offer basic connectivity.
The vehicle checks whether the triggering conditions to adapt its behaviour configuration are met. From the description in the Section above, we have three conditions to be met: (i) the vehicle is parked (or expected to be parked within a short time); (ii) the vehicle is expected to be in a location where normal coverage is not available while operations in CE mode are expected to provide basic connectivity; (iii) the vehicle requires basic sensor reporting services when parked. The reception of QoS prediction of coverage change from normal coverage to coverage enhancement helps to check point (ii) of the triggering conditions. The vehicle then checks points (i) and (iii), if those points apply the vehicle decides to adapt its behaviour configuration from normal coverage to coverage enhancement.
The vehicle triggers the reaction to change the behaviour configuration from normal coverage to coverage enhancement. One possible reaction is that the vehicle initiates a procedure to change its chipset capability from operations in normal coverage to operations in CE mode. This reaction can be described as follows. The application at the vehicle side is able to configure the UE chipset via an API allowing the reconfiguration of UE's capabilities, in particular the configuration of UE capability regarding the support of operations in CE mode. When the UE chipset is configured to change its support of operations in CE mode, the UE chipset initiates a procedure of attachment to the mobile network, where the UE signals the support of the capability of operations in CE mode. With this procedure, the network is then aware that the UE can be reached in CE mode and the UE is able to benefit from coverage enhancement.

NOTE: a more detailed description of the reaction, considering also feasibility analyses, is FFS.
After the completion of the reaction triggered by the vehicle, the vehicle updates its behaviour configuration, which is now coverage enhancement. The vehicle is then configured to use only application associated to basic sensor reporting. Once vehicle' configuration is update, the vehicle informs the other communication end-point(s), e.g., its own OEM's cloud, about the configuration currently in use. This allows OEM's cloud to adapt its behaviour configuration as well, e.g., disable all applications except basic connectivity for vehicle's status check.
The completion of the reaction triggered by the vehicle might also involve a configuration behaviour adaptation at the network side. In this case, the switch of UE capability regarding the support of CE mode triggers the adaptation of behaviour configuration at the network that now is in coverage enhancement status (i.e., the network enforces CE-specific features, as for instance specific policies for rate limitation, different charging, change of UE/traffic priority, etc.).

2.2 Network Reaction to Prediction of Coverage Change

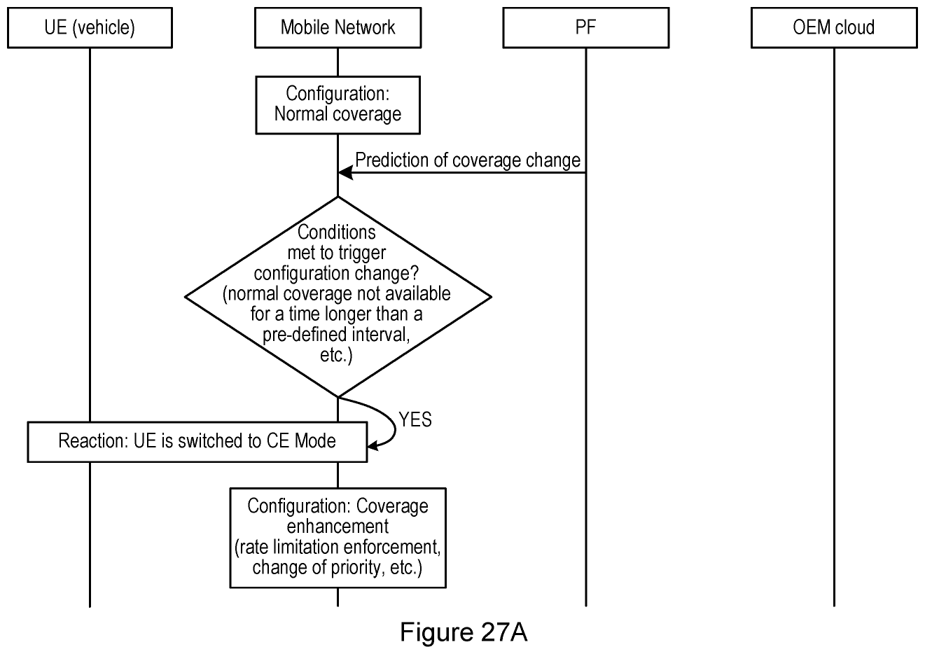

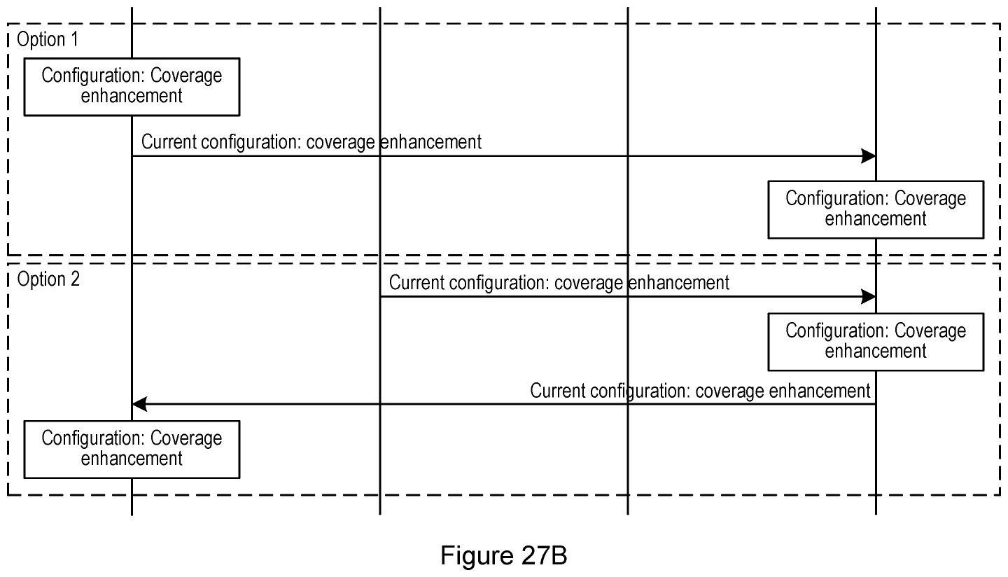

The flow diagram of network reaction to the reception of QoS Prediction of coverage change is depicted in FIG. 27A-B. In this example, it is assumed that the receivers of the QoS Prediction message from the Prediction Function (PF) is the network. The application reaction can be described as follows:
The network is in the initial behaviour configuration associated to normal coverage. In this configuration, the network manages the UE in a normal mode and the network does not enforce any particular behaviour for the UE (in addition to usual configuration for admission control, QoS management, priority, etc.).
NOTE: In this example, it is assumed that the network is already aware that the UE is able to support operations in CE mode and that the network is able to configure the UE to use or not CE mode. It is FFS to provide more details on how the network identifies and authorizes UEs able to support operations in both normal coverage and CE mode. A preliminary study can be found in 5GAA_A-190038 [3].
The network receives the QoS Prediction of coverage change from the PF, indicating that the vehicle is expected to lose normal coverage within a certain time interval and that coverage enhancements operations can be used to offer basic connectivity.
The network checks whether the triggering conditions to adapt its behaviour configuration are met. From the description in the Section above, we have three conditions to be met: (i) it is predicted that the UE will not be reachable by means of normal coverage and that the unreachability is expected to last longer that a certain time interval; (ii) the UE is predicted to be reachable by using CE mode; (iii) the network is expected to have enough resources to serve the UE using CE mode. The reception of QoS prediction of coverage change from normal coverage to coverage enhancement helps to check point (i) and (ii) of the triggering conditions. The network then checks point (iii), and if this point applies the network decides to adapt its behaviour configuration from normal coverage to coverage enhancement.
The network triggers the reaction to change the behaviour configuration from normal coverage to coverage enhancement. One possible reaction is that the network initiates a procedure to change the UE's channel configuration to enforce the utilization of CE mode. This reaction can be achieved by using the RRCConnectionReconfiguration procedure (3GPP TS 36.331, § 5.3.5), where the ce-Mode element (included in the PhysicalConfigDedicated element carried by the radioResourceConfigDedicated element, 3GPP TS 36.331, § 6.3.2) is set to “setup” and for instance to “ce-ModeA” (i.e., the network triggers a physical channel re-configuration configuring the UE to use CE mode).

NOTE: a more detailed description of the reaction, considering also feasibility analyses, is FFS.
After the completion of the reaction, the network updates its behaviour configuration, which is now coverage enhancement. The network enforces CE-specific features, as for instance specific policies for rate limitation, different charging, change of UE/traffic priority, etc.
The completion of the reaction triggered by the network might also involve a configuration behaviour adaptation at the application side. In this case, two options can be considered:
   Option 1. The physical channel re-configuration with the enabling of utilization of CE mode triggers the adaptation of behaviour configuration at the vehicle. In this case, the UE modem is able to monitor the change of CE mode status and exposes such information to the vehicle's application, which adapts its behaviour configuration to coverage enhancement. The vehicle is then configured to use only application associated to basic sensor reporting. Once vehicle's configuration is updated, the vehicle informs the other communication end-point(s), e.g., its own OEM's cloud, about the configuration currently in use. This allows OEM's cloud to adapt its behaviour configuration as well, e.g., disable all applications except basic connectivity for vehicle's status check.
   Option 2. The network exposes the information about the change of coverage mode with which the UE is served (i.e., the information that the UE is now operating in CE mode), e.g., via the NEF towards the OEM's AF. At the reception of such information, the OEM's cloud triggers the update of behaviour configuration to coverage enhancement, e.g., disable all applications except basic connectivity for vehicle's status check. Once OEM's cloud configuration is updated, the OEM's cloud information the vehicle about the configuration currently in use, vehicle which then adapts its behaviour configuration to coverage enhancement using only applications associated to basic sensor reporting.

### 3 CONCLUSIONS

Behaviour configuration of possible adaptation status for application and/or network;
Triggering conditions for behaviour configuration adaptation.
Reactions taken to adapt the behaviour configuration including relevant modem/chipset settings, adaptation of applications at UE and server side, network procedures, network settings, etc.

### 4 REFERENCE

[1] 5GAA_A-190002, 5GAA Work Item Description, Enhanced E2E Network Slicing and Predictive QoS.
[2] 5GAA_A-190076, eNESQO TR Skeleton.
[3] 5GAA_A-190038, Seamless integration of vehicles as IoT devices using LTE-M.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
AF Application Function
CE Coverage enhancement
NEF Network Exposure Function
OEM Original Equipment Manufacture
PCF Policy Control Function
SCS/AS Services Capability Server/Application Server
SMF Session Management Function
RAN Radio Access Network
UE User Equipment
UPF User Plane Function
V2X Vehicle to everything
1×RTT CDMA2000 1× Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1.-144. (canceled)

145. A method performed by a wireless device that comprises radio equipment and terminal equipment, the method comprising:
receiving connection reconfiguration signaling from a wireless communication network at the radio equipment of the wireless device, wherein the connection reconfiguration signaling indicates reconfiguration of a connection that the radio equipment has with the wireless communication network;
responsive to receiving the connection reconfiguration signaling, determining, at the radio equipment, whether to transmit notification signaling to the terminal equipment of the wireless device; and
if it is determined that the notification signaling is to be transmitted to the terminal equipment of the wireless device, transmitting, from the radio equipment to the terminal equipment of the wireless device, the notification signaling, wherein the notification signaling notifies the terminal equipment of the reconfiguration of the connection.

146. The method of claim 145, wherein said determining comprises determining whether the indicated reconfiguration of the connection is a type of reconfiguration of which the radio equipment is to notify the terminal equipment.

147. The method of claim 145, further comprising filtering the received connection reconfiguration signaling to extract one or more parameters characterizing the reconfiguration of the connection, and whether the notification signaling includes or is based on the one or more parameters extracted.

148. The method of claim 145, further comprising:
receiving, at the terminal equipment of the wireless device, the notification signaling indicating reconfiguration of the connection that the radio equipment of the wireless device has with the wireless communication network, wherein the notification signaling is received if it is determined at the radio equipment that the notification signaling is to be transmitted to the terminal equipment of the wireless device.

149. The method of claim 148, wherein the connection supports data transfer between the wireless device and endpoint communication equipment, and wherein the notification signaling is received from the endpoint communication equipment.

150. The method of claim 145, further comprising:
transmitting, from the terminal equipment of the wireless device to endpoint communication equipment, notification signaling indicating one or more of:
reconfiguration of the connection that the radio equipment of the wireless device has with the wireless communication network; and
adaptation of one or more parameters at the terminal equipment in accordance with the reconfiguration of the connection;
wherein the connection supports data transfer between the wireless device and the endpoint communication equipment.

151. The method of claim 145, further comprising, based on the reconfiguration of the connection, adapting one or more parameters at the terminal equipment.

152. The method of claim 151, wherein the one or more parameters govern:
generation and/or transfer of data between the wireless device and endpoint communication equipment; and/or
a rate, amount, and/or latency of data transfer between the wireless device and endpoint communication equipment.

153. The method of claim 151, wherein said adapting comprises:
adapting the one or more parameters according to the reconfiguration of the connection;
adapting the one or more parameters to enable or disable a specific application executable by the terminal equipment;
adapting the one or more parameters to adjust priorities among multiple traffic flows between the wireless device and endpoint communication equipment; and/or
adapting a rate, amount, and/or latency of data transfer between the wireless device and endpoint communication equipment to be supportable by the connection as reconfigured.

154. The method of claim 145, wherein the notification signaling indicates how the connection is reconfigured.

155. The method of claim 145, wherein the reconfiguration of the connection comprises setup or release of a coverage enhancement mode for the connection.

156. The method of claim 145, wherein the wireless device is capable of:
transmitting or receiving over a frequency bandwidth greater than 1.08 MHz; and/or
vehicle-to-everything communication.

157. A method performed by a radio network node configured for use in a wireless communication network, the method comprising:
transmitting connection reconfiguration signaling from the radio network node to a wireless device, wherein the connection reconfiguration signaling indicates reconfiguration of a connection that radio equipment of the wireless device has with the radio network node;
determining, at the radio network node, whether to transmit notification signaling to a core network node in the wireless communication network; and
if it is determined that the notification signaling is to be transmitted to the core network node, transmitting, from the radio network node to the core network node, the notification signaling, wherein the notification signaling notifies the core network node of the reconfiguration of the connection.

158. The method of claim 157, wherein said determining comprises determining whether the indicated reconfiguration of the connection is a type of reconfiguration of which the radio network node is to notify the core network node.

159. The method of claim 157, further comprising filtering the received connection reconfiguration signaling to extract one or more parameters characterizing the reconfiguration of the connection, and whether the notification signaling includes or is based on the one or more parameters extracted.

160. A method performed by a core network node configured for use in a wireless communication network, the method comprising:
receiving, from a radio network node in the wireless communication network, notification signaling indicating reconfiguration of a connection that radio equipment of a wireless device has with the radio network node, wherein the notification signaling is received if it is determined at the radio network node that the notification signaling is to be transmitted to the terminal equipment of the wireless device.

161. The method of claim 160, further comprising:
transmitting, from the core network node towards endpoint communication equipment, notification signaling indicating one or more of:
reconfiguration of the connection that radio equipment of the wireless device has with the radio network node; and
adaptation of one or more parameters at the core network node in accordance with the reconfiguration of the connection;
wherein the connection supports data transfer between the wireless device and the endpoint communication equipment.

162. The method of claim 161, wherein transmitting the notification signaling towards the endpoint communication equipment comprises transmitting the notification signaling to an application function associated with the endpoint communication equipment.

163. The method of claim 160, further comprising, based on the reconfiguration of the connection, adapting one or more parameters at the core network node.

164. The method of claim 161, wherein the one or more parameters include one or more parameters of a network policy for treating data transferred between the wireless device and endpoint communication equipment.

165. A wireless device comprising:
terminal equipment; and
radio equipment configured to:
receive, at the radio equipment, connection reconfiguration signaling from a wireless communication network, wherein the connection reconfiguration signaling indicates reconfiguration of a connection that the radio equipment has with the wireless communication network;
responsive to receiving the connection reconfiguration signaling, determine, at the radio equipment, whether to transmit notification signaling to the terminal equipment of the wireless device; and
if it is determined that the notification signaling is to be transmitted to the terminal equipment of the wireless device, transmit, from the radio equipment to the terminal equipment of the wireless device, the notification signaling, wherein the notification signaling notifies the terminal equipment of the reconfiguration of the connection.

166. A radio network node configured for use in a wireless communication network, the radio network node comprising:
communication circuitry; and
processing circuitry configured to:
transmit connection reconfiguration signaling from the radio network node to a wireless device, wherein the connection reconfiguration signaling indicates reconfiguration of a connection that radio equipment of the wireless device has with the radio network node;
determine, at the radio network node, whether to transmit notification signaling to a core network node in the wireless communication network; and
if it is determined that the notification signaling is to be transmitted to the core network node, transmit, from the radio network node to the core network node, the notification signaling, wherein the notification signaling notifies the core network node of the reconfiguration of the connection.

167. A core network node configured for use in a wireless communication network, the core network node comprising:
communication circuitry; and
processing circuitry configured to receive, from a radio network node in the wireless communication network, notification signaling indicating reconfiguration of a connection that radio equipment of a wireless device has with the radio network node, wherein the notification signaling is received if it is determined at the radio network node that the notification signaling is to be transmitted to the terminal equipment of the wireless device.
